(19) United States
(12) Patent Application Publication
(10) Pub. No.: US 2026/0051517 A1
(43) Pub. Date: Feb. 19, 2026

(54) BIPOLAR PLATES WITH VARIABLE FURCATION RATIOS

(71) Applicant: HYDROGENICS CORPORATION, Mississauga (CA)

(72) Inventors: Salvatore RANIERI, Etobicoke (CA); Rainey Yu WANG, Richmond Hill (CA)

(21) Appl. No.: 19/101,633

(22) PCT Filed: Aug. 25, 2023
(86) PCT No.: PCT/IB2023/058448

§ 371 Date: Feb. 6, 2025

Related U.S. Application Data
(60) Provisional application No. 63/401,447, filed on Aug. 26, 2022.

(51) Int. Cl. H01M 8/0263; H01M 8/10

(52) U.S. Cl. CPC H01M 8/0263; H01M 2008/1095

(57) ABSTRACT

A bipolar plate includes a sheet having channels formed on a surface of the sheet, each channel including a header region, an active region, and an exhaust region. The channels are formed adjacent to each other and successively from a top side to a bottom side of the sheet. The active region is furcated into at least two active area channels along a longitudinal length of the active region from where the active region fluidically connects to the header region to where the active region fluidically connects to the exhaust region. A number of active area channels in the active regions of successive channels varies in one of a direction from the top side to the bottom side or a direction from the bottom side to the top side so as to achieve a uniform pressure drop and mass flow distribution across the plurality of channels.

### CROSS-REFERENCE TO RELATED APPLICATIONS

This non-provisional application claims the benefit and priority, under 35 U.S.C. § 119(e) and any other applicable laws or statutes, to U.S. Provisional Patent Application Ser. No. 63/401,447 filed Aug. 26, 2022, the entire disclosure of which is hereby expressly incorporated herein by reference.

### TECHNICAL FIELD

The present disclosure generally relates to fuel cell assemblies, and in particular, bipolar plates of fuel cell assemblies.

### BACKGROUND

A single fuel cell is one of many repeating units of a fuel cell stack that may provide power or energy for personal and/or industrial use. The typical proton exchange membrane (PEM) fuel cell is a multi-component assembly that often comprises a membrane electrode assembly (MEA) at the center, a gas diffusion layer (GDL) on either side of the membrane electrode assembly (MEA), and a bipolar plate (BPP) on either side of the gas diffusion layer (GDL). Typically, a PEM fuel cell and/or fuel cell stack is assembled with the aforementioned components to operate in a useful and reliable manner.

In many mobility applications, the reactants supplied to the fuel cell are pure hydrogen for the anode and an oxidant for the cathode. A cooling system is often required to provide a heat sink to manage excess heat produced during the electrochemical reactions and to keep the fuel cell at an appropriate temperature during operation.

The stack of fuel cells typically has common aligned features that allow for a single supply and return for the anode fluid, cathode fluid, and coolant. These aligned features create a stack-long cavity for each fluid, which simultaneously facilitates the supply and return of all the fluids to the fuel cells in a parallel flow configuration. From the common supply manifold each bipolar plate bleeds off a near equal portion of reactants and coolant to support the electrochemical process. The bipolar plate is therefore responsible for efficiently guiding the reactants and coolant to and from the active areas around the gas diffusion layers and the membrane electrode assembly and isolating, or sealing, the fluid to within its respective pathways, all while being electrically conductive and mechanically robust. The small pathways that travel over the length of the bipolar plate are referred to as the flow field(s). The flow field consists of millimeter scale channel networks which direct the bulk supply of fluid and diffuse the fluid in a specific manner over the active portion of the fuel cells. The active area of the fuel cell is the main portion of the fuel cell where both the anode and cathode flow fields are directly overlapping with the respective open-faced channel exposed directly overtop the gas diffusion layers and subsequently the membrane electrode assembly.

In mobility applications of a fuel cell system, although the bulk of the main fluids is supplied by air, fuel, and coolant systems at the engine level, the robustness of design at the fuel cell level is dictated by the bipolar plate, and more specifically how flow fields of any bipolar plate are designed. Distribution of reactants and coolant fluids can be important to enable a powerful, efficient, and robust fuel cell stack foundation. In some scenarios, once pumping machinery for either of the reactants or coolant, has forced those constituents through a fuel cell stack manifold, the individual bipolar plate can then intake its proportion of the main supply of reactants or coolant. The portion of the main supply can then be evenly distributed over the entire width of the bipolar plate. The desired result is to have a near-exact amount of fluid mass flow through each of the individual bipolar plates, even distribution between each flow field channel, and a near-uniform pressure drop within the channels. Having spatial uniformity ensures several subsequent effects to also happen uniformly. The subsequent effects include current distribution, heat generation, and/or efficiency, all of which indirectly affect fuel cell life and robustness.

Accordingly, it would be advantageous to provide a fuel cell assembly, and in particular, a bipolar plate or bipolar plate designed to achieve substantially even mass flow therethrough, substantially even distribution between each flow field channel, and/or substantially even pressure drop within the channels.

### SUMMARY

Embodiments of the present invention are included to meet these and other needs.

In one aspect, described herein, a bipolar plate assembly for a fuel cell includes a first bipolar sheet including a plurality of channels. The plurality of channels are formed on a first surface of the first bipolar sheet and extend from a first side of the first bipolar sheet to a second side of the first bipolar plate opposite the first side. The plurality of channels each include a header region, an active region fluidically downstream of and connected to the header region, and an exhaust region fluidically downstream of and connected to the active region. The plurality of channels are formed adjacent to each other and successively from a one side of the first bipolar sheet to another side of the first bipolar sheet. The active region of each channel of the plurality of channels is furcated into at least two active area channels along a longitudinal length of the active region of the channel from a location at which the active region fluidically connects to the header region to a location at which the active region fluidically connects to the exhaust region such that a fluid flows through the header region, through each active area channel, and through the exhaust region. A number of active area channels in the active regions of successive channels varies in a direction from the one side to the another side of the first bipolar sheet so as to achieve a uniform pressure drop and mass flow distribution across the plurality of channels.

In some embodiments, the header region of each channel of the plurality of channels may be a single channel or is furcated into at least two header region channels, and wherein a furcation ratio of each channel may be defined as a number of header region channels to the number of active area channels of the channel. In some embodiments, the furcation ratio of successive channels may increase in the direction from the one side to the another side of the first bipolar sheet.

In some embodiments, the plurality of channels may be grouped into at least two groups of channels each including at least one channel of the plurality of channels, and wherein the increase in the furcation ratio of successive groups of channels may be linear from a topmost group of channels to a bottommost group of channels. In some embodiments, the plurality of channels may be grouped into at least four groups of channels each including at least one channel of the plurality of channels, and wherein the increase in the furcation ratio of successive groups of channels may be parabolic from a topmost group of channels to a bottommost group of channels.

In some embodiments, the plurality of channels may be grouped into five groups of channels each including at least one channel of the plurality of channels, wherein a first group of channels of the five groups of channels may have a furcation ratio of 1:6, wherein a second group of channels of the five groups of channels may have a furcation ratio of 1:7, wherein a third group of channels of the five groups of channels may have a furcation ratio of 1:8, wherein a fourth group of channels of the five groups of channels may have a furcation ratio of 1:9, and wherein a fifth group of channels of the five groups of channels may have a furcation ratio of 1:10.

In some embodiments, the plurality of channels may be grouped into at least four groups of channels each including at least one channel of the plurality of channels, wherein a first group of channels of the at least four groups of channels may be located adjacent the one side of the first bipolar sheet and may have a furcation ratio of 3:8, wherein a second group of channels of the at least four groups of channels may be located adjacent the another side of the first bipolar sheet and may have a furcation ratio of 3:19, and wherein a remaining at least two groups of the at least four groups may include furcation ratios that increase parabolically from the first group to the second group.

In some embodiments, the header region of each channel of the plurality of channels may be defined between two elongated header lands, and wherein the active region of each channel may be defined between two elongated active lands. In some embodiments, a transition region between the header region and the active region of each channel may include at least one island land arranged therein and that is spaced apart from the elongated header lands and the elongated active lands.

In some embodiments, a normalized mass flow of the fluid flowing through the active regions of the plurality of channels may vary by a maximum of 10%.

According to a second aspect, described herein, a bipolar plate sheet for a bipolar plate for a fuel cell includes a plurality of channels. The plurality of channels are formed on a first surface of the bipolar plate sheet. The plurality of channels each include an active region. The plurality of channels are formed successively from a top side of the first bipolar sheet to a bottom side of the bipolar plate sheet. The active region of each channel of the plurality of channels is furcated into at least two active area channels. A number of active area channels in the active regions of successive channels increases in one of a direction from the top side to the bottom side of the bipolar plate sheet or a direction from the bottom side to the top side of the bipolar plate sheet so as to achieve a uniform pressure drop and mass flow distribution across the plurality of channels.

In some embodiments, a header region of each channel may be fluidically connected to and upstream of the active region of the channel, wherein the header region of each channel may be a single channel or may be furcated into at least two header region channels, and wherein a furcation ratio of each channel may be defined as a number of header area channels to the number of active area channels of the channel. In some embodiments, the furcation ratio of successive channels may increase in the direction from the top side to the bottom side of the bipolar plate sheet, and wherein the number of active area channels may be greater than the number of header channels in each channel.

In some embodiments, the plurality of channels may be grouped into at least two groups of channels each including at least one channel of the plurality of channels, and wherein the increase in the furcation ratio of successive groups of channels may be linear from a topmost group of channels to a bottommost group of channels. In some embodiments, the plurality of channels may be grouped into at least four groups of channels each including at least one channel of the plurality of channels, and wherein the increase in the furcation ratio of successive groups of channels may be parabolic from a topmost group of channels to a bottommost group of channels.

In some embodiments, the plurality of channels may be grouped into five groups of channels each including at least one channel of the plurality of channels, wherein a first group of channels of the five groups of channels may have a furcation ratio of 1:6, wherein a second group of channels of the five groups of channels may have a furcation ratio of 1:7, wherein a third group of channels of the five groups of channels may have a furcation ratio of 1:8, wherein a fourth group of channels of the five groups of channels may have a furcation ratio of 1:9, and wherein a fifth group of channels of the five groups of channels may have a furcation ratio of 1:10. In some embodiments, the plurality of channels may be grouped into at least four groups of channels each including at least one channel of the plurality of channels, wherein a first group of channels of the at least four groups of channels may be located adjacent the top side of the bipolar plate sheet and may have a furcation ratio of 3:8, wherein a second group of channels of the at least four groups of channels may be located adjacent the bottom side of the bipolar plate sheet and may have a furcation ratio of 3:19, and wherein a remaining at least two groups of the at least four groups may include furcation ratios that increase parabolically from the first group to the second group.

In some embodiments, the header region of a respective channel may begin as a single header channel and may furcate into at least two header region channels which extend into the active region of the respective channel, wherein the exhaust region of the respective channel may be furcated into at least two exhaust region channels at an exit of the active region of the respective channel and may converge into a single exhaust channel, and wherein a number of channels of the at least two exhaust region channels may be different that a number of channels of the at least two header region channels.

In some embodiments, the header region of a respective channel may begin as a single header channel and may furcate into at least two header region channels which extend into the active region of the respective channel, wherein the exhaust region of the respective channel may be furcated into at least two exhaust region channels at an exit of the active region of the respective channel and may converge into a single exhaust channel, and wherein a number of channels of the at least two exhaust region channels may be equal to a number of channels of the at least two header region channels.

According to a third aspect, described herein, a method of forming a bipolar plate sheet includes forming a plurality of channels on a first surface of the bipolar plate sheet. The plurality of channels extend from a first side of the first bipolar sheet to a second side of the first bipolar plate opposite the first side. The plurality of channels each include a header region, an active region fluidically downstream of and connected to the header region, and an exhaust region fluidically downstream of and connected to the active region. The plurality of channels are formed adjacent to each other and successively from a top side of the first bipolar sheet to a bottom side of the first bipolar sheet. The method further includes furcating the active region of each channel of the plurality of channels into at least two active area channels along a longitudinal length of the active region of the channel from a location at which the active area fluidically connects to the header region to a location at which the active area fluidically connects to the exhaust region such that a fluid flows through the header region, through each active area channel, and through the exhaust region. A number of active area channels in the active regions of successive channels increases in one of a direction from the top side to the bottom side of the first bipolar sheet or a direction from the bottom side to the top side of the first bipolar sheet so as to achieve a uniform pressure drop and mass flow distribution across the plurality of channels.

### BRIEF DESCRIPTION OF DRAWINGS

The detailed description particularly refers to the following figures in which:

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is a top view of a bipolar plate according to the present disclosure configured to be used in the fuel cell stack of FIG. 1A;

FIG. 3A is a perspective view of inlet channels and active channels of the bipolar plate of FIG. 2;

FIG. 3B is a perspective view of the inlet channels and the active channels of the bipolar plate of FIG. 2;

FIG. 3C is a perspective view of two separate sheets that form the bipolar plate of FIG. 2;

FIG. 3D is a perspective view of a top sheet of the two separate sheets shown in FIG. 3C;

FIG. 4 is a conceptual view of the bipolar plate of FIG. 2, showing three distinct paths of fluid flow through the plate;

FIG. 5A is a graph showing pressure contour results along a first of the three distinct paths shown in FIG. 4;

FIG. 5B is a graph showing pressure contour results along a second of the three distinct paths shown in FIG. 4;

FIG. 5C is a graph showing pressure contour results along a third of the three distinct paths shown in FIG. 4;

FIG. 6 is a graph showing computational fluid dynamics (CFD) results of all active channels of a bipolar plate having a constant furcation ratio with normalized mass flow versus normalized channel location;

FIG. 7A is top view of a variable furcation ratio bipolar plate according to a further aspect of the present disclosure configured to be used in the fuel cell stack of FIG. 1A;

FIG. 7B is an enlarged top view of the inlet distribution area of the bipolar plate of FIG. 7A;

FIG. 8 is top view of a variable furcation ratio bipolar plate according to a further aspect of the present disclosure configured to be used in the fuel cell stack of FIG. 1A;

FIG. 9 is top view of a variable furcation ratio bipolar plate according to a further aspect of the present disclosure configured to be used in the fuel cell stack of FIG. 1A;

FIG. 10A is top view of a variable furcation ratio bipolar plate according to a further aspect of the present disclosure configured to be used in the fuel cell stack of FIG. 1A;

FIG. 10B is a graph showing the relationship between channel count and channel location relative to the inlet of the bipolar plate of FIG. 10A;

FIG. 11A is a top view of a progression of furcation ratios of the bipolar plate of FIG. 10A from a top side of the plate to the bottom side of the plate;

FIG. 11B is a top view of a progression of furcation ratios of the bipolar plate of FIG. 10A from a top side of the plate to the bottom side of the plate;

FIG. 11C is a top view of a progression of furcation ratios of the bipolar plate of FIG. 10A from a top side of the plate to the bottom side of the plate;

FIG. 11D is a top view of a progression of furcation ratios of the bipolar plate of FIG. 10A from a top side of the plate to the bottom side of the plate;

FIG. 11E is a top view of a progression of furcation ratios of the bipolar plate of FIG. 10A from a top side of the plate to the bottom side of the plate;

FIG. 11F is a top view of a progression of furcation ratios of the bipolar plate of FIG. 10A from a top side of the plate to the bottom side of the plate;

FIG. 11G is a top view of a progression of furcation ratios of the bipolar plate of FIG. 10A from a top side of the plate to the bottom side of the plate;

FIG. 11H is a top view of a progression of furcation ratios of the bipolar plate of FIG. 10A from a top side of the plate to the bottom side of the plate;

FIG. 11I is a top view of a progression of furcation ratios of the bipolar plate of FIG. 10A from a top side of the plate to the bottom side of the plate;

FIG. 11J is a top view of a progression of furcation ratios of the bipolar plate of FIG. 10A from a top side of the plate to the bottom side of the plate;

FIG. 11K is a top view of a progression of furcation ratios of the bipolar plate of FIG. 10A from a top side of the plate to the bottom side of the plate;

FIG. 12 is a graph showing CFD results of all active channels of a bipolar plate having a parabolically increasing furcation ratio with normalized mass flow versus normalized channel location;

FIG. 13 is a graph showing a PEM fuel cell polarization (POL) curve with highlighted losses;

FIG. 14A is a schematic view of channel geometries of active channels of an active area of the bipolar plate of FIG. 2;

FIG. 14B is a schematic view of channel geometries of inlet distribution channels of a distribution area of the bipolar plate of FIG. 2;

FIG. 14C is a schematic view of the active area and distribution areas of the bipolar plate of FIG. 2;

FIG. 15 is a schematic view of a bipolar plate according to a further aspect of the present disclosure, showing that the inlet distribution channels of the distribution areas can have a reduced land width channel geometry;

FIG. 16 is a schematic view of a bipolar plate according to a further aspect of the present disclosure, showing that the inlet distribution channels of the distribution areas can have a reduced land width channel geometry;

FIG. 17 is a schematic view of a bipolar plate according to a further aspect of the present disclosure, showing that lands of inlet distribution channels of the distribution areas can be segmented;

FIG. 18A is a schematic view of a bipolar plate according to a further aspect of the present disclosure, showing that inlet distribution channels can vary in width from a top of a manifold to a bottom of the manifold, and showing that the inlet distribution channels can vary in width through the distribution area; and

FIG. 18B is a schematic view of a bipolar plate according to a further aspect of the present disclosure, showing that inlet distribution channels can vary in width from a top of a manifold to a bottom of the manifold, and showing that the width of the inlet distribution channels can be constant through the distribution area.

### DETAILED DESCRIPTION

The fuel cell system 10 described herein, may be used in a stationary and/or an immovable power system, such as industrial applications and power generation plants. The fuel cell system 10 may also be implemented in conjunction with an air delivery system 18. Additionally, the fuel cell system 10 may be implemented in conjunction with a fuel or hydrogen delivery system and/or a source of hydrogen 19, such as a pressurized tank. The pressurized tank may include a gaseous pressurized tank, a cryogenic liquid storage tank, chemical storage, physical storage, stationary storage, an electrolysis system and/or an electrolyzer.

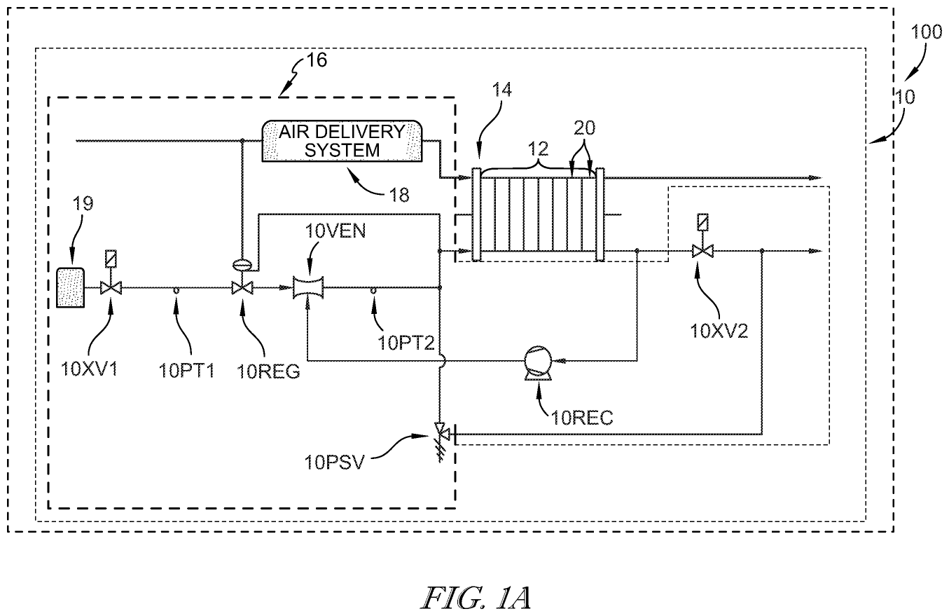

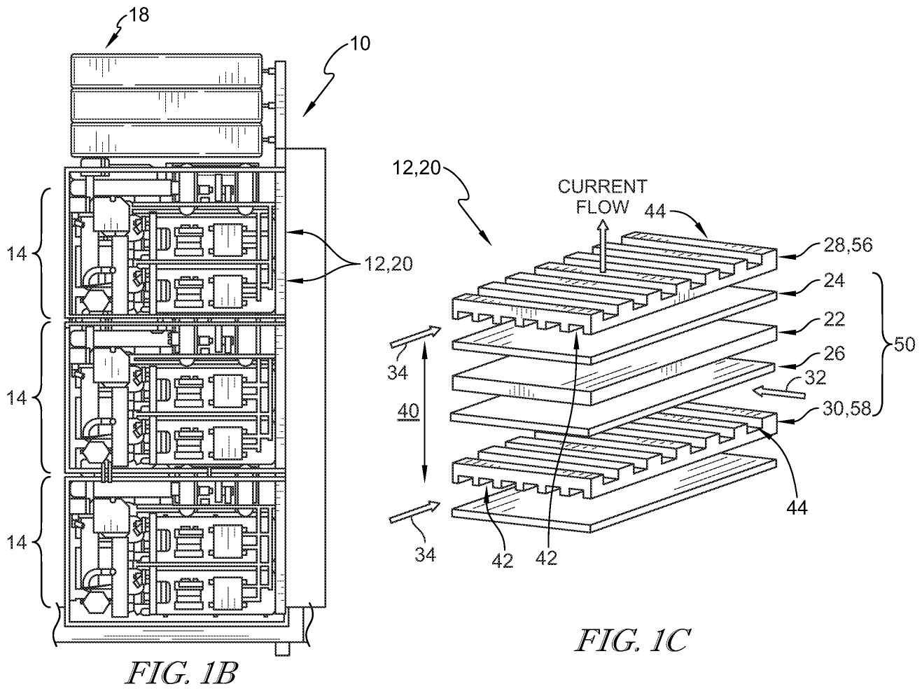

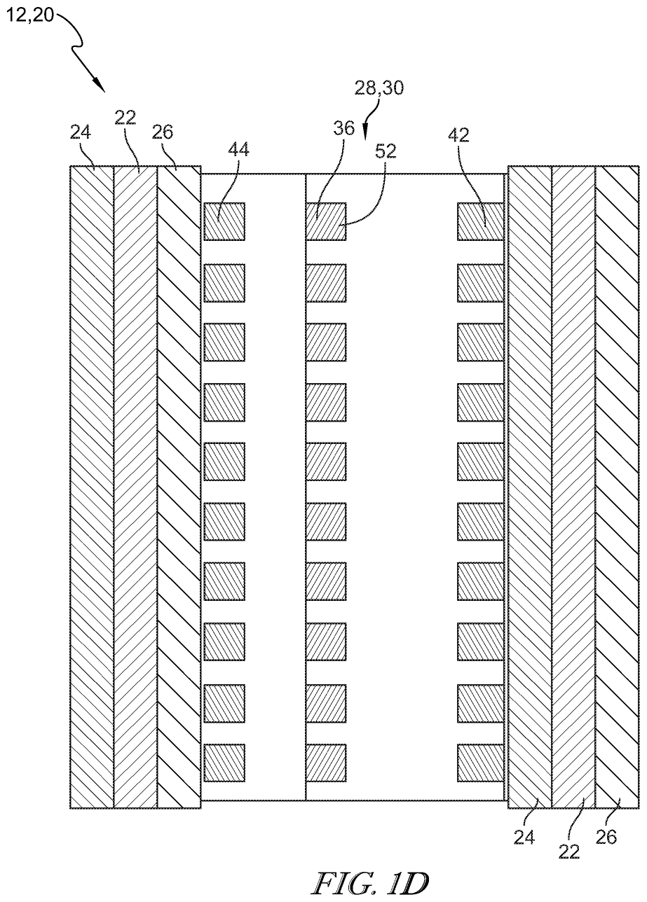

In one embodiment, the fuel cell system 10 is connected and/or attached in series or parallel to the hydrogen delivery system and/or the source of hydrogen 19. The hydrogen delivery system and/or the source of hydrogen 19 may include one or more hydrogen delivery systems and/or a source of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, as shown in FIG. 1A, the fuel cell system 10 may include an on/off valve 10XV1, a pressure transducer 10PT1, a mechanical regulator 10REG, and/or a venturi 10VEN. These components (e.g., 10XV1, 10PT1, 10REG, 10VEN) may be arranged in operable communication with each other. One or more of these components may also be located downstream of the hydrogen delivery system and/or the source of hydrogen 19. In some embodiments, the on/off valve 10XV1, the pressure transducer 10PT1, the mechanical regulator 10REG, and/or the venturi 10VEN may be arranged in operable communication with each other and located downstream of the hydrogen delivery system and/or the source of hydrogen 19.

The pressure transducer 10PT1 may be arranged between the on/off valve 10XV1 and the mechanical regulator 10REG. In some embodiments, a proportional control valve may be utilized instead of or substituted for the mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC. The recirculation pump 10REC may be located downstream of the stack 12. The recirculation pump 10REC may also be operably connected to the venturi 10VEN.

The fuel cell system 10 may also include a further on/off valve 10XV2 as shown in FIG. 1A. The on/off valve 10XV2 may be located downstream of the stack 12. The fuel cell system 10 may also include a pressure transfer valve 10PSV.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. Fuel cells 20 may also be referred to as electrochemical cells 20. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). For example, in some embodiments, the features and attributes described herein as related to the fuel cell bipolar plates (BPP) 28, 30 may also relate to and/or be incorporated by one or more electrolyzer plates 56, 58. In further embodiments, the features and aspects described or taught in the present disclosure do not relate, and are therefore distinguishable from, those of an electrolyzer, an electrolyzer stack, and/or an electrolyzer cell (EC).

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14, as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The present disclosure is directed to systems, assemblies, and methods, and in particular bipolar plate assemblies and methods of creating such assemblies, configured to achieve substantially even mass flow therethrough, substantially even distribution between each flow field channel, and substantially even pressure drop within the channels. In some embodiments described herein, the bipolar plate assemblies can include a furcation ratio between active channels of the bipolar plate that vary along a top-down direction of the bipolar plate. In some embodiments, the bipolar plate assemblies may include a modified channel geometry including reduced land widths relative to the groove widths of the channels.

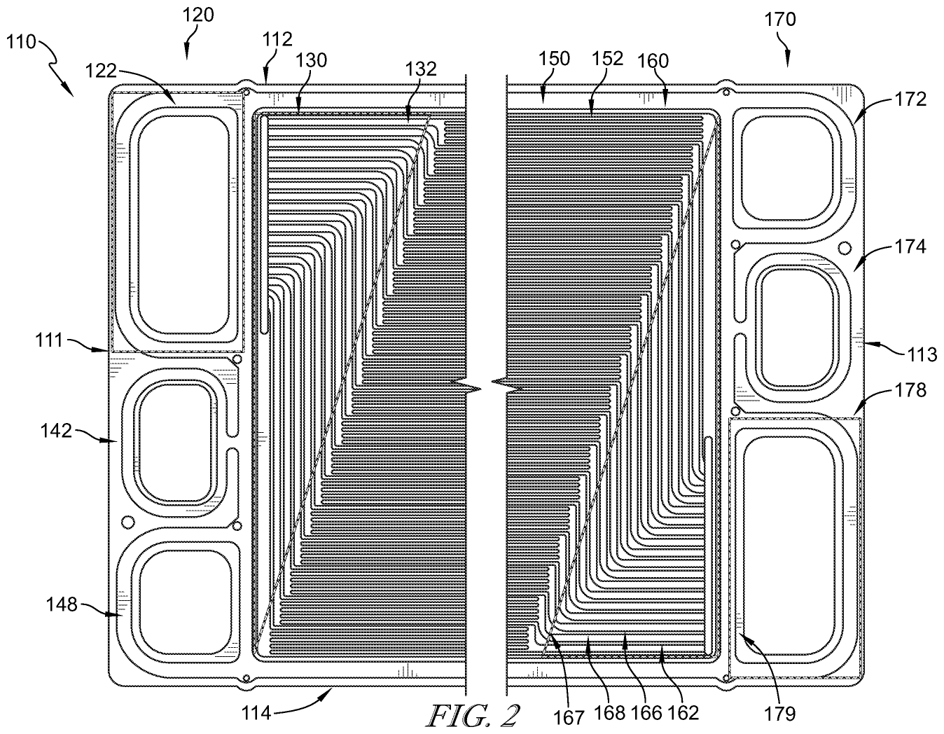

The bipolar plates 110, 210, 310, 410, 510, 610, 710, 810, 810′ also referred to as bipolar plate assemblies, according to the present disclosure may be utilized along with or in place of the bipolar plates 28, 30 of the fuel cell system 10 described above in reference to FIGS. 1A-1D. A known bipolar plate that may be utilized as the bipolar plate 28, 30 of the fuel cell system 10 is described below as the bipolar plate 110, as shown in FIGS. 2-7.

A person skilled in the art will understand that the bipolar plate 110, 210, 310, 410, 510, 610, 710, 810, 810′ described with regard to FIGS. 2-18B, as well as any other configuration or embodiment of such a bipolar plate described herein, can be utilized as a bipolar plate within any electrochemical system, such as an electrolysis system (e.g., an electrolyzer), an electrolyzer stack, and/or an electrolyzer cell (EC), as opposed to or in conjunction with the fuel cell 20 described above. For example, in some embodiments, the features and attributes described herein as related to the fuel cell bipolar plates (BPP) 28, 30 may also relate to and/or be incorporated by one or more electrolyzer plates 56, 58. Alternatively, there may be some embodiments where the present the bipolar plate 110, 210, 310, 410, 510, 610, 710, 810, 810′ described with regard to FIGS. 2-18B, as well as any other configuration or embodiment of such a bipolar plate described herein, cannot or will not be utilized as a bipolar plate within any electrochemical system, such as an electrolysis system (e.g., an electrolyzer), an electrolyzer stack, and/or an electrolyzer cell (EC), and therefore cannot or will not be utilized as an electrolyzer plate 56, 58.

Depending on the size and location of manifolds 122, 142, 148, 172, 174, 178 of the bipolar plate 110 with respect to the flow channels 132, 152, 162, the design of the bipolar plate 110 may leverage a distribution area (e.g., distributions areas 130, 160) within their respective flow fields. Flow fields are areas in which the flow channels 132, 152, 162 extend and carry fluid therethrough. In at least one embodiment, as shown in FIG. 2, the bipolar plate 110 may be responsible for the transport of reactants 32, 34 and cooling fluid 36 in a fuel cell, such as the fuel cell 20 of the fuel cell stack 12.

The bipolar plate 110 may be comprised of one or more formed sheets 192, 196 of material bonded or welded adjacent to each other. By way of non-limiting examples, the plate 110 may be formed of one, two, three, or more sheets 192, 196. Illustratively, the plate 110 is formed of two layered sheets 192, 196.

The material of the sheets 192, 196 may comprise about 20% to about 100% metal, including any percentage or range of percentages of metal comprised therein (e.g., 20%, 25%, 30%, 40%, 50%, 60%, 70%, 75%, 80%, 90%, and 100%). Typically, a sheet 192, 196 of a metal bipolar plate 110 may comprise about 50% to about 100% metal, including any percentage or range of percentage of metal comprised therein. In an exemplary embodiment, the sheet 192, 196 of the metal bipolar plate 110 may comprise about 50% to about 100% metal, including any percentage or range of percentage of metal comprised therein. In another embodiment, the sheet 192, 196 of the metal bipolar plate 110 may comprise about 90% to about 100% metal, including any percentage or range of percentage of metal comprised therein.

The material and/or structure of the metal bipolar plate 110 is important to the conductivity of the fuel cell 20 or the fuel cell stack 12. In some embodiments, the material of the bipolar plate 110 is graphite. Similarly, the material of the bipolar plate 110 may or may not be any similar or different powder-based product, such as a graphite-based powder. In some embodiments, powder-based products (e.g., the graphite-based powder) may be prepared by an impregnation and/or solidifying process.

Generally, graphite and other such materials of the bipolar plate 110 do not have the capacity to retain sufficient strength or uniformity to support the fuel cell 20 or the fuel cell stack 12 without maintaining a certain minimum width or thickness. However, metal as a material of the bipolar plate 110 has considerably lower limitations, restrictions, and/or considerations.

The metal of the bipolar plate 110 may be any type of electrically conductive metal, including but not limited to austenitic stainless steel (304L, 316L, 904L, 310S), ferritic stainless steel (430, 441, 444, Crofer), Nickel based alloys (200/201, 286, 600, 625), titanium (Grade 1, Grade 2), and/or aluminum (1000 series, 3000 series). Exemplary metals comprised by the metal bipolar plate 110 may be steel, iron, nickel, aluminum, and/or titanium, or combinations thereof.

The sheets 192, 196 of the metal bipolar plate 110 may be sealed, welded, stamped, structured, bonded, and/or configured to provide the flow fields for the fuel cell fluids 32, 34, 36 (e.g., two, three, or more fluids). One or more sheets 192, 196 of the metal bipolar plate 110 are configured to be in contact, to overlap, to be attached, or connected to one another in order to provide the flow fields for the fuel cell fluids 32, 34, 36.

In some embodiments, one or more sheets 192, 196 of the metal bipolar plate 110 may be coated for corrosion resistance using any method known in the art (e.g., spraying, dipping, electrochemically bathing, adding heat, etc.) to form a coating. In some embodiments, the coating may be or comprise metal including, but not limited to, zinc, chromium, nickel, gold, platinum, and various alloys or combinations thereof. In other embodiments, the coating may be a graphite-based coating that protects, reduces, delays, and/or prevents the bipolar plate 110 from corroding (e.g., rusting, deteriorating, etc.). Since graphite has the inability to oxidize, it may be advantageous to coat the metal of the bipolar plate 110 with the graphite-based coating to provide additional protection to corrosion and degradation of the plate 110.

As shown in FIG. 2, the bipolar plate 110 includes an inlet manifold region 120, an inlet distribution area 130, an active area 150, an exhaust distribution area 160, and/or an exhaust manifold region 170. The inlet manifold region 120 can include a first manifold 122 (also referred to as a port 122), a second manifold 142, and a third manifold 148. Each manifold 122, 142, 148 may be formed as a sizable opening formed towards a first side 111 of the plate 110. In some embodiments, the outer contours of each manifold 122, 142, 148 may match the contour of the outer edge of the plate 110 on the first side 111 of the plate 110.

As can be seen in FIG. 2, the first manifold 122 is located in an upper left corner of the plate 110. The first manifold 122 includes a plurality of inlet channels 124, which may also be referred to as a feed portion 124. The inlet channels 124 are configured to facilitate feeding of the fluids 32, 34, 36 described above into the active area 150 of the plate 110 so as to interact with the associated gas diffusion layers 24, 26.

A person skilled in the art will understand that a plurality of inlet channels 124, or the feed portion 124 is not limited to only the first manifold 122. The other manifolds 142, 148 may also include feed portions in some embodiments of the present disclosure. In particular, some embodiments of the plate 110 may further include the manifolds 172, 174, 178 formed on an opposing second side 113 of the plate 110, as described below.

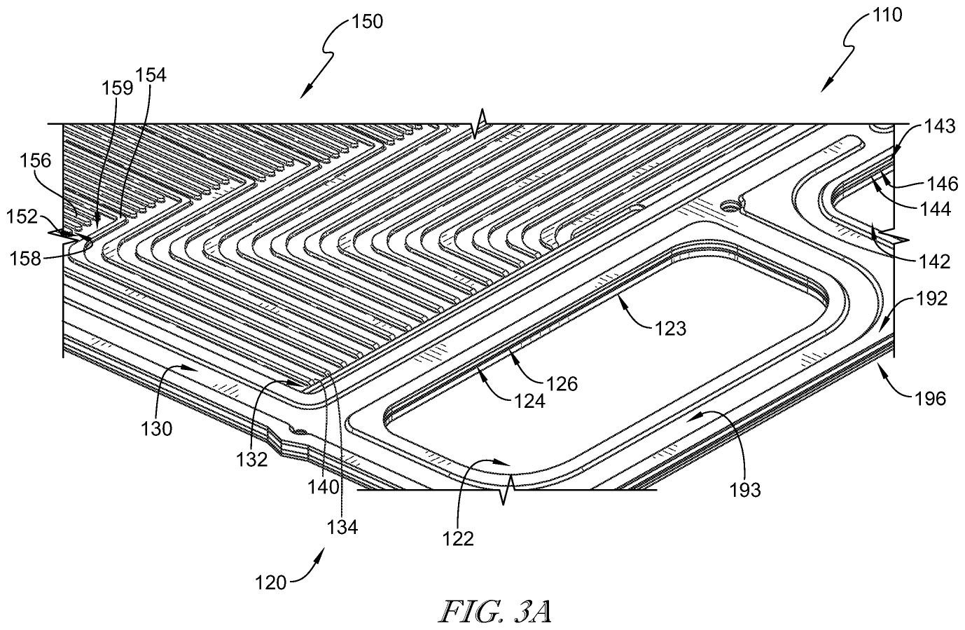

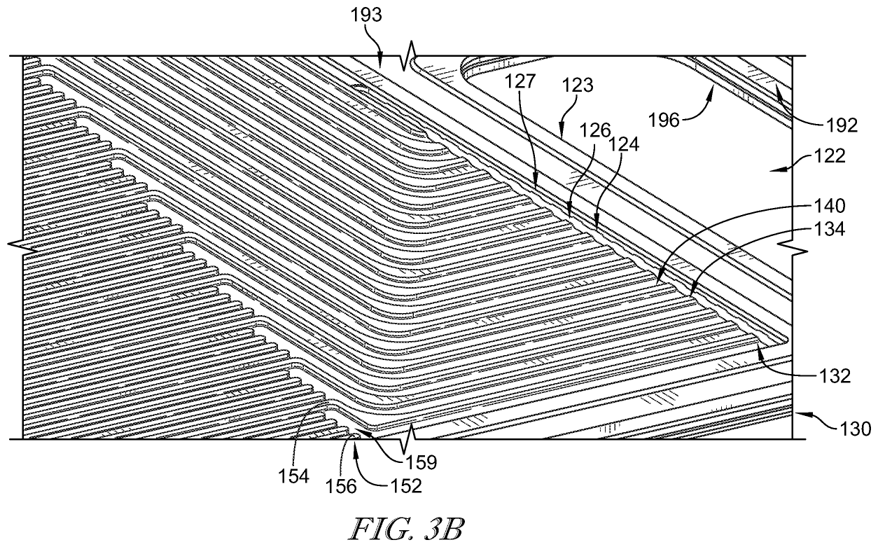

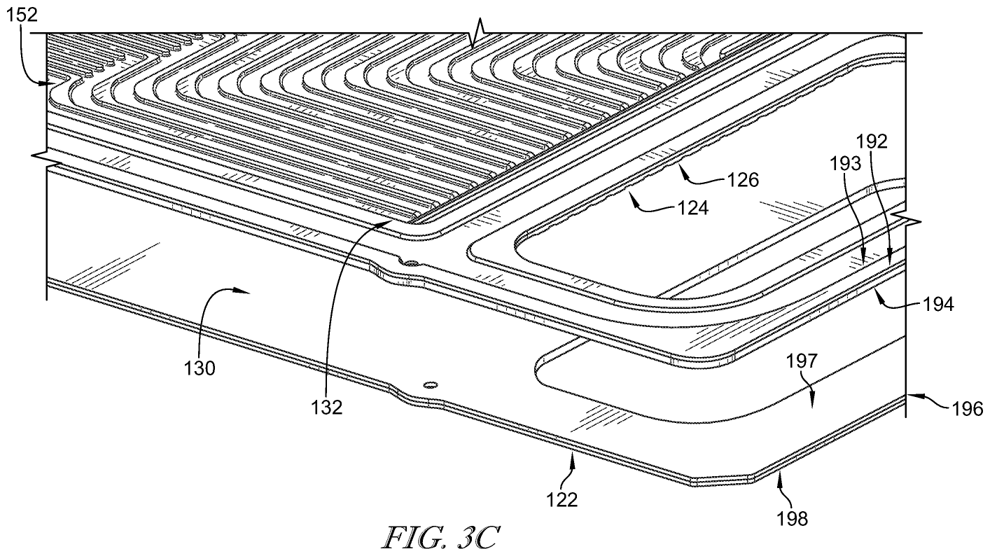

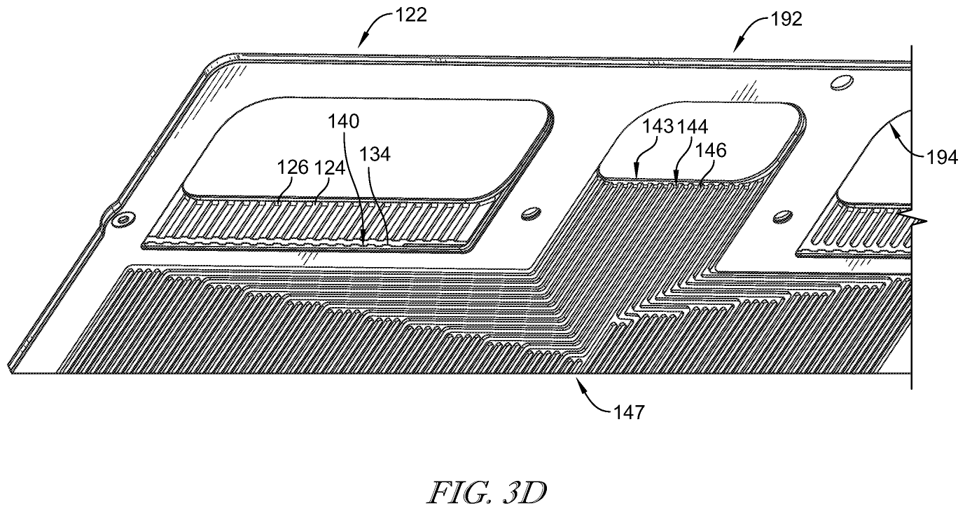

A person of ordinary skill in the art will understand that, although the manifolds 122, 142, 148, 172, 174, 178 are shown as generally rectangular shapes in FIGS. 3A-3D, the manifolds 122, 142, 148, 172, 174, 178 may be formed in any shape, including but not limited to triangular, circular, and/or other shapes. Moreover, a person skilled in the art will understand that the plurality of inlet channels 124 described herein may be applicable to any of the other channels, such as, for example, the inlet distribution channels 132 and/or a plurality of inlet coolant channels 144. A person skilled in the art will understand that any features of the manifold regions 120, 170 described herein may be applicable to any of the other manifold regions 120, 170. A person skilled in the art will understand that any features of the distributions areas 130, 160 described herein may be applicable to any of the other distributions areas 130, 160.

Similar to the manifolds 122, 142, 148, the bipolar plate 110 further includes a fourth manifold 172, a fifth manifold 174, and/or a sixth manifold 178, as shown in FIG. 2. Each manifold 172, 174, 178 may be formed as a sizable opening formed towards the second side 113 of the plate 110. The second side 113 is opposite the first side 111 of the plate 110 on which the manifolds 122, 142, 148 are formed. In some embodiments, the outer contours of each manifold 172, 174, 178 may match the contour of the outer edge of the plate 110 on the second side 113 of the plate 110.

As shown in FIG. 2, the sixth manifold 178, also referred to as an exhaust manifold 178, is located on a lower right corner of the plate 110. The exhaust manifold 178 includes an exhaust portion 179 configured to facilitate removal of the fluids 32, 34, 36 away from the active area 150 of the plate 110. In particular, the fluid 32, 34, 36 is configured to flow through exhaust distribution channels 162, through the exhaust portion 179 and out of the exhaust manifold 178.

In an illustrative embodiment, the first manifold 122 is formed as an inlet manifold and the sixth manifold 178 is formed as an exhaust manifold. A person skilled in the art will understand that different manifolds 142, 148, 172, 174 may be formed as inlets and exhausts. Alternatively combinations of specific manifolds may include all inlets and exhausts formed on the same side 111, 113 of the plate 110 or on differing sides 111, 113 of the plate 110, as shown in the illustrated embodiment of FIG. 2.

In some embodiments (see FIG. 2), a height of the inlet and exhaust manifolds 122, 178, as measured in a first direction from a longitudinal top side 112 of the plate 110 to an opposing, longitudinal bottom side 114 of the plate 110, are considerably shorter in the first direction than the height of the active area 150. It is on these inlet and exhaust manifolds 122, 178 that the reactants 32, 34, 36 can enter or exit the distribution areas 130, 160, and also the active area 150. Thus, the distributions areas 130, 160 must be designed in a way that enables an even dispersion of reactant 32, 34, 36 over the active area 150.

Illustratively, the bipolar plate 110 is comprised of two sheets 192, 196 layered on top of each other to form the bipolar plate 110, as shown in detail in FIGS. 3A-3D. Each sheet 192, 196 includes a cut-out area defining one half of the manifolds 122, 142, 148, 172, 174, 178 described above. When the sheets 192, 196 are arranged on top of each other, each manifold 122, 142, 148, 172, 174, 178 of the bipolar plate 110 is formed.

Some embodiments may comprise a top sheet 192, also known as the first sheet 192, and a bottom sheet 196, also known as the second sheet 196. In some embodiments, a bottom surface 194 of the top sheet 192 and a top surface 197 of the bottom sheet 196 may be planar. Additionally, the bottom surface 194 of the top sheet 192 may be planar. The bottom surface 194 of the top sheet 192 may be arranged on a top surface 197 of the bottom sheet 196.

As can be seen in FIG. 3A, each sheet 192, 196 of the bipolar plate 110 includes protrusions and/or indentations that form channels 132, 152, 162 that define the distribution areas 130, 160 and active area 150 of FIG. 2. For example, the inlet distribution area 130 includes the plurality of inlet distribution channels 132 that extend from the inlet manifold 122 to active channels 152 formed in the active area 150. In particular, the inlet manifold 122 includes a plurality of inlet channels 124 formed on an inner side 123 of the inlet manifold 122. The inlet channels 124 are fluidically connected to the inlet distribution channels 132 so as to distribute reactant 32, 34, such as fuel 32 (e.g., hydrogen) or oxidant 34 (e.g., oxygen, air), from the inlet manifold 122 to the inlet distribution area 130.

The plurality of inlet channels 124 are defined between spaced apart protrusions 126. The protrusions 126 extend away from the bottom surface 194 of the first sheet 192. For example, the protrusions 126 may extend in a direction away from the inner side 123 toward the inlet distribution area 130 and/or terminate at an exhaust side 127 of the inlet manifold 122.

The plurality of inlet distribution channels 132 are formed as grooves 140 between elongated protrusions 134. The plurality of inlet distribution channels 132 may also form lands 134 that protrude away from a top surface 193 of the first sheet 192 (see FIGS. 3A and 3B). In an exemplary embodiment, the plurality of inlet distribution channels 132 comprise both grooves 140 and lands 134, often in an alternating format.

A person skilled in the art will understand that the inlet distribution area 130 can include any number of inlet distribution channels 132 extending therein, as required by the bipolar plate 110 and fuel cell stack 12 design. By way of non-limiting examples, the inlet distribution area 130 can include between 5 and 10 inlet distribution channels 132, between 10 and 20 inlet distribution channels 132, and between 20 and 30 inlet distribution channels 132. In some embodiments, the inlet distribution area 130 can include 18 inlet distribution channels 132.

As can be seen in FIG. 2, the inlet distribution channels 132 must extend in such a way so as to extend into every active channel 152 of the active area 150. As will be described in detail below, the active channels 152 may be wider than the inlet distribution channels 132. Thus, in some embodiments, the inlet distribution channels 132 may extend away from the inlet manifold 122 and turn in a downward direction away from the longitudinal top side 112 of the bipolar plate 110. Then, the inlet distribution channels 132 may fluidically connect to its corresponding active channel 152 in the active area 150.

For example, since a topmost active channel 152 is located adjacent to the longitudinal top side 112 of the plate 110, the corresponding inlet distribution channel 132 would not be required to bend downwardly to connect to the topmost active channel 152. However, a bottommost active channel 152 is located adjacent to the longitudinal bottom side 114 of the plate 110, while the corresponding inlet distribution channel 132 is located at a bottom side of the inlet manifold 122. Thus, the corresponding inlet distribution channel 132 would be required to bend downwardly and extend downwardly toward the longitudinal bottom side 114 of the plate 110 in the first direction to connect to the bottommost active channel 152.

FIGS. 3A and 3B show that each inlet distribution channel 132 opens into a corresponding active channel 152 of the active area 150. Illustratively, the active channels 152 are defined between end protrusions 154 or end lands 154. The end protrusions or lands 154 protrude upwardly away from the top surface 193 of the first sheet 192 and extend longitudinally along the active area 150 from the inlet distribution area 130 to the exhaust distribution area 160. In some embodiments, each end land 154, and thus each active channel 152, extends parallel to the top and bottom sides 112, 114 of the bipolar plate 110.

A person skilled in the art will understand that the active channels 152 can extend in different directions relative to the top and bottom sides 112, 114, as long as the active channels 152 fluidically interconnect the inlet and exhaust distribution areas 130, 160. In some embodiments, the active channels 152 can extend perpendicular to the downwardly extending portions of the inlet distribution channels 132, as shown in FIG. 2.

Illustratively, each active channel 152 may furcate at an inlet transition region 159 of the active channel 152 into the multiple furcated channels 158. The multiple furcated channels 158 are formed between furcating lands 156 that are located within the active channel 152. The active channels 152 protrude upwardly away from the top surface 193 of the first sheet 192 and extend lengthwise along the active channel 152.

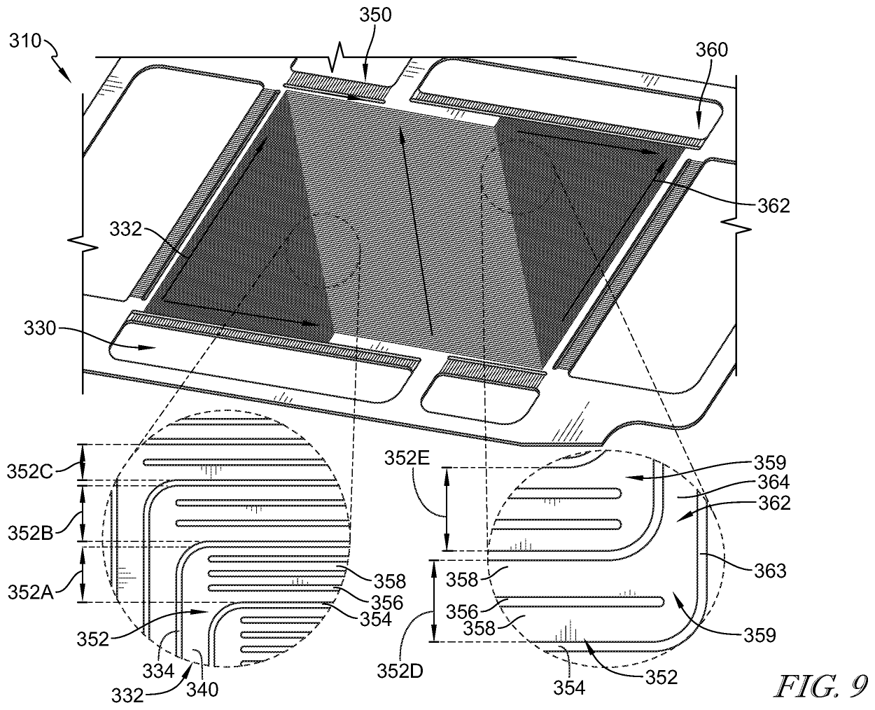

In some embodiments, the furcating lands 156 extend from the inlet transition region 159, where the corresponding inlet distribution channel 132 fluidically connects to the active channel 152, to a similarly formed outlet transition region that opens in the exhaust distribution channels 162 (not shown in FIGS. 3A and 3B, but see transition region 359 as shown in FIG. 9). The outlet transition region is where the corresponding exhaust distribution channel 162 of the exhaust distribution area 160 fluidically connects to the active channel 152. In some embodiments, each furcated channel 158 of each active channel 152 has the same width, although in other embodiments, the widths of adjacent furcated channels 158 can vary.

In some embodiments, the furcation of each active channel 152 may be referred to as a furcation ratio. The furcation ratio is determined relative to the furcation of the corresponding inlet distribution channel 132. For example, if the inlet distribution channel 132 does not furcate, it would have a furcation value of 1. If the corresponding active channel 152 furcates into four furcated channels 158, the active channel 152 would have a furcation value of 4. Thus, the furcation ratio of the channel (e.g., the inlet distribution channel 132 and the active channel 152) would be 1:4.

As can be seen in FIG. 3D, the bottom surface 194 of the first sheet 192 can include cooling channels 147 formed therein. The second manifold 142 may include the plurality of inlet coolant channels 144 defined between a plurality of spaced apart protrusions 146. The plurality of spaced apart protrusions 146 extend away from the bottom surface 194. For example, the plurality of spaced apart protrusions 146 extend in a direction away from an inner side 143 of the second manifold 142 toward the inlet distribution area 130. The inlet coolant channels 144 can be configured to facilitate feeding of a cooling fluid 36 (e.g., coolant and/or water) from the second manifold 142 into the cooling channels 147. The cooling channels 147 may be distributed along the bottom surface 194 of the first sheet 192 in any configuration understood by a person skilled in the art.

A person skilled in the art will also understand that the exhaust distribution area 160 can also include a plurality of exhaust distribution channels 162 arranged therein, as shown in FIG. 2. The exhaust distribution channels 162 can be formed substantially similar to the inlet distribution channels 132, including elongated lands 166 and grooves 168 formed therebetween, which form the exhaust distribution channels 162. Similar to the inlet distribution channels 132, the exhaust distribution channels 162 each fluidically interconnect an exit 167 of a corresponding active channel 152 to the exhaust manifold 178. Thus, at least some of the exhaust distribution channels 162 must bend at some point to reach the exhaust manifold 178, as shown in FIG. 2. The particular geometry of the exhaust distribution channels 162 may be symmetrical to the inlet distribution channels 132. In other embodiments, the exhaust distribution channels 162 may be asymmetrical to the inlet distribution channels 132.

Although not shown, the second sheet 196 may include similar or exactly the same distribution channels 132, 152, 162 formed on its bottom surface 198. In the illustrated embodiment, the bipolar plate 110 is configured to engage both an anode gas diffusion layer 24 and a cathode gas diffusion layer 26. In particular, one of the distribution channels 132, 152, 162 formed on the top surface 193 of the first sheet 192 may be configured to engage the anode gas diffusion layer 24. The other of the distribution channels 132, 152, 162 formed on the bottom surface 198 of the second sheet 196 may be configured to engage the cathode gas diffusion layer 26.

The direction of flow, the depth, and other parameters of the distribution channels 132, 152, 162 of each sheet 192, 196 may be optimized for whichever of the anode and cathode gas diffusion layers 24, 26 that the distribution channels 132, 152, 162 are engaged with, as a person skilled in the art will understand. As described above, multiple bipolar plates 110 may be stacked relative to each other with diffusion layer assemblies, in particular a single membrane electrode assembly (MEA) 22 and a gas diffusion layer (GDL) 24, 26, arranged between the plates 110.

Referring back to FIG. 2, a flow field pattern of the distribution areas 130, 160 and the active area 150 of the bipolar plate 110 that is completely symmetric is shown. If the bipolar plate 110 is rotated 180° clockwise or counterclockwise, as viewed in FIG. 2, the exact same form factor would be observed. Additionally, the distribution channels 132, 152, 162 start and stop at the same junction, thus creating a parallel flow configuration with near exact lengths. The mentioned geometric symmetry produces an even flow distribution as long as the constituents (e.g., reactants and coolant) do not change appreciably and the mass flow is reasonably conserved. However, in operation of the fuel cell system 10, constituents may change, and the mass flow may not be conserved.

By way of a non-limiting example, a PEM fuel cell 20 and a corresponding bipolar plate 110 that is supplied with pure hydrogen 32 is subject to the following chemical equation (i.e., Equation 1) on the anode side of the MEA 22 (e.g., the anode gas diffusion layer 24). A person skilled in the art will understand that the left and right side of this equation do not balance due to a discontinuity through the MEA 22.

$${λ}_{an} {H}_{2} + {ϕ}_{rh} {H}_{2} O \to {( {λ}_{an} - 1 )}_{2} + ( {x}_{rev} + {ϕ}_{rh} ) {H}_{2} O \qquad ( 1 )$$

In Equation 1, λₐₙ is the stoichiometric multiplier (“stoich”), ϕᵣₕ signifies humidity added to the inlet stream, and xᵣₑᵥ is the reverse osmotic drag that often accompanies the reverse reaction within the electrolyte of the membrane. A typical PEM fuel cell 20 can be supplied with a stoich of about 1.1 to about 1.5, including any specific stoich comprises therein. The PEM fuel cell 20 may also comprise an inlet relative humidity of about 30% and/or may experience about 10% product water osmotic drag through the membrane from the cathode reaction. Because of the consumption of (λₐₙ−1) from the left to the right side of Equation 1, there is a relatively large discontinuity of volume from inlet 122 to outlet 178. This discontinuity can have considerable effects on the spatial distribution within the bipolar plate 110 without particular consideration.

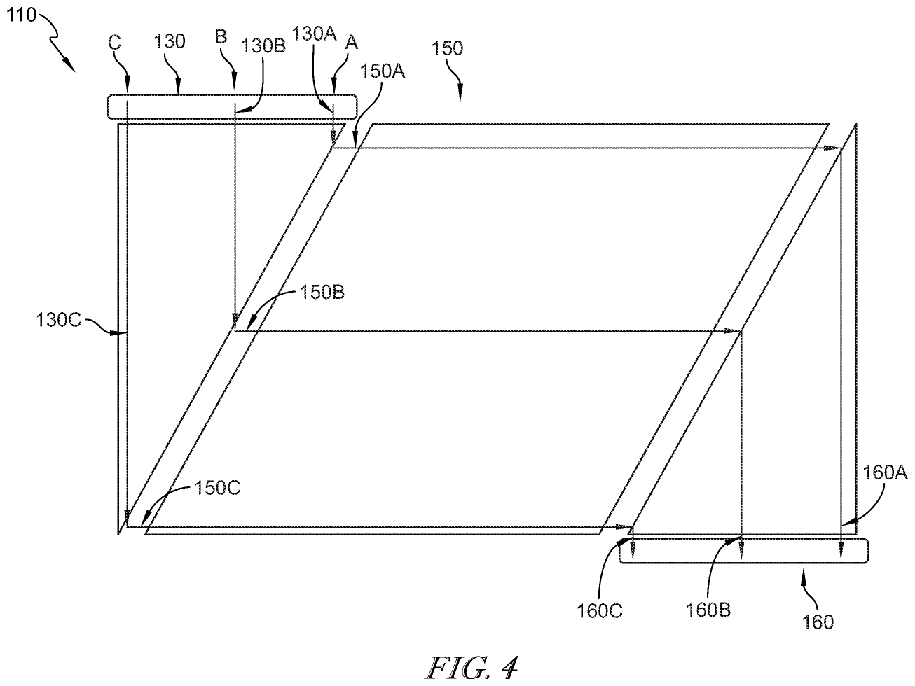

FIG. 4 shows three conceptual paths of fluid flowing through the bipolar plate 110. In one non-limiting example, Path A includes paths 130A, 150A, 160A. Path A has the shortest inlet distribution area 130 path 130A, followed by the active area 150 path 150A, and then lastly, the longest exhaust distribution area 160 path 160A.

Additionally, Path B includes paths 130B, 150B, 160B. Path B has a medium length inlet distribution area 130 path 130B, followed by the active area 150 path 150B, and then lastly, a medium length exhaust distribution area 160 path 160B. Path C includes paths 130C, 150C, 160C. Path C has the longest inlet distribution area 130 path 130C, followed by the active area 150 path 150C, and then lastly, the shortest exhaust distribution area 160 path 160C.

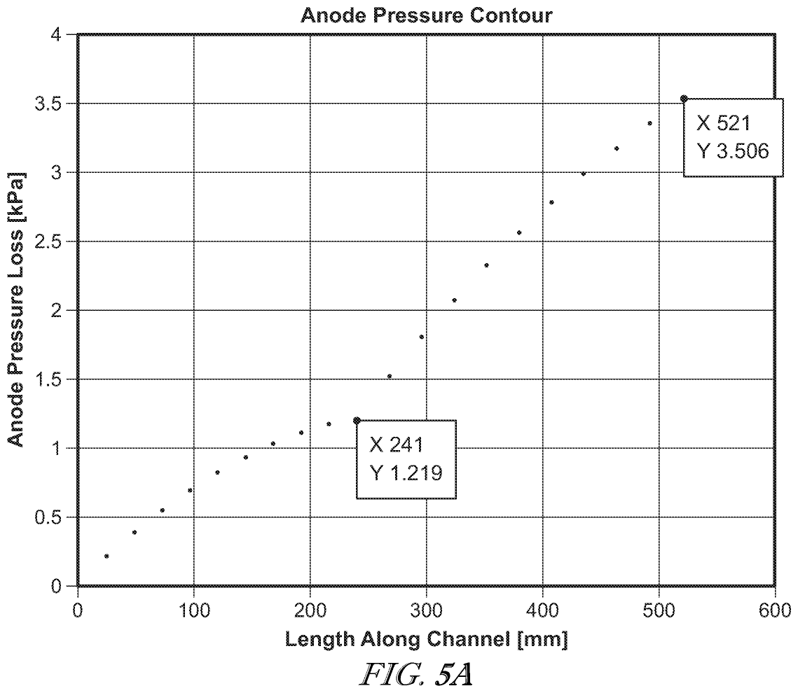

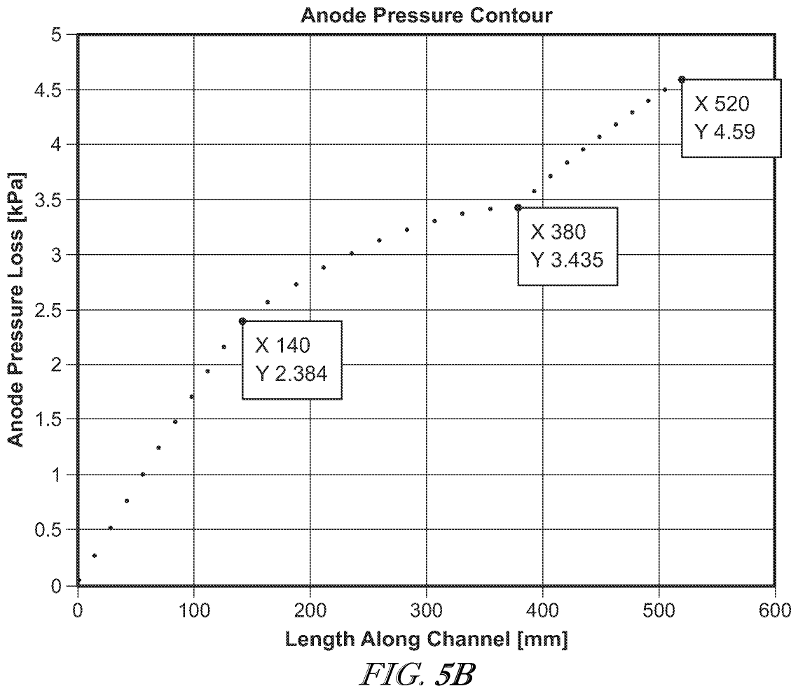

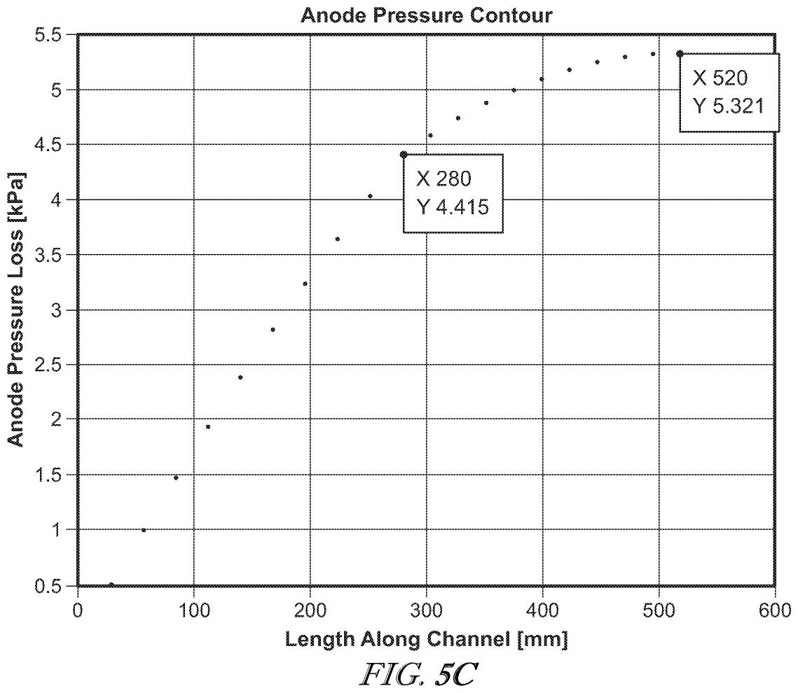

The three Paths A, B, C, are considered to be in a parallel flow configuration. This parallel flow configuration is a reasonable approximation within the bipolar plate 110 of a study of three unique pressure drops, as shown in FIGS. 5A-5C. Pressure drop is a consequence of any fluid flow (e.g., gaseous or liquid) in or around an object. A fully developed and confined fluid flow can be characterized with Equation 2:

$$dP = f ρ \frac{L}{{D}_{h}} \frac{{V}^{2}}{2} \qquad ( 2 )$$

In Equation 2 above, pressure drop is labeled as dP, and f is the friction factor, which is a function of the fluid viscosity, velocity, and roughness of the network. L and Dh are the length and hydraulic diameters of the network, respectively. V is the average velocity of the fluid.

FIG. 5A shows the pressure contour results along Path A. FIG. 5B shows the pressure contour results along Path B. FIG. 5C shows the pressure contour results along Path C.

The study of three unique pressure drops, as shown in FIGS. 5A-5C, considered a bipolar plate 110 having a constant furcation ratio of about 3:8 between every inlet distribution channel 132 and its corresponding active channel 152. The results show that the total pressure drop between the two most extremes varies from about 3.5 kPa to about 5.3 kPa, including all values of pressure drop comprised therein.

The varying pressure drop occurs because the main portion of the active area 150 of the bipolar plate 110 is responsible for a considerable amount of consumption of hydrogen 32. The consumption of hydrogen 32 essentially causes a spatially dependent reduction in pressure drop. The results will change depending on whether the consumption happened before or after a long distribution area path.

The three region paths (e.g., inlet distribution area paths 130A, 130B, 130C, active area paths 150A, 150B, 150C, and exhaust distribution area paths 160A, 160B, 160C) of the three Paths A, B, C were analyzed individually. When the distribution channels 132, 152, 162 were to operate concurrently, the pressure drop would equalize and the mass flow distribution would compensate until an equilibrium was met. The results can be seen in Table 1, which shows pressure and stoich estimates for the path lengths shown in FIG. 4:

TABLE 1

| | Pressure | Pressure | Pressure | | |
|---|---|---|---|---|---|
| | Drop on | Drop on | Drop on | | |
| | Inlet | Active | Exhaust | | |
| (kPa) | Path (A) | Path (B) | Path (C) | Sum | Stoich Est. |
| 1. | ~0 | 1.219 | 2.287 | 3.506 | 1.785779 |
| 2. | 2.384 | 1.0513 | 1.1544 | 4.5897 | 1.364128 |
| 3. | 4.4154 | 0.9052 | ~0 | 5.3206 | 1.176736 |

Table 1 shows the pressure drop and estimated volumetric (stoich) distribution of the reactants 32, 34 under Equation 1 and under the geometries posed in FIG. 4. The targeted stoich in the analysis was set to 1.4 and the target is nearly achieved through the middle path (Path B). However, the end cases have been biased to Path A. Consequently, the bottom path (e.g., Path C) is severely starved of the targeted flow and a stoich of 1.17 is likely to cause efficiency and reliability issues if operated for prolonged periods of time.

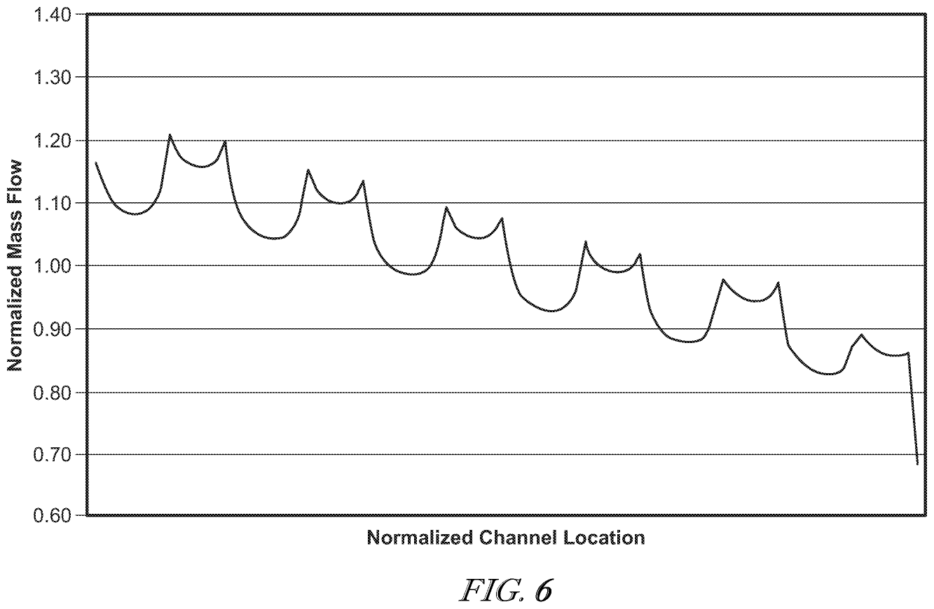

FIG. 6 shows a graph of normalized mass flow versus normalized channel location of computational fluid dynamics (CFD) results of all active channels 152 of a bipolar plate 110 having a constant furcation ratio. As can also be seen in FIG. 6, the resulting normalized mass flow fluctuated between +/−20% of a normalized target mass flow having a stoich of approximately 1.4 along all pathways.

One method of correcting the mass distribution is to have a furcation ratio that changes over the height of the bipolar plate 110 to achieve a symmetric pressure drop, rather than a symmetric geometry, as shown in FIGS. 2 and 4. The goal of the variable furcation ratio design is to shift the consumption responsible for each branch 158 or channel path 158 to achieve a near equal pressure drop and subsequently an equal mass flow distribution within the distribution channels 132, 152, 162. The furcation ratio may vary linearly, parabolically, logarithmically, monotonically, and/or have any mathematical correlation that enables a channel-to-channel balance for all of the branches 158, or furcated channels 158, within the active area 150.

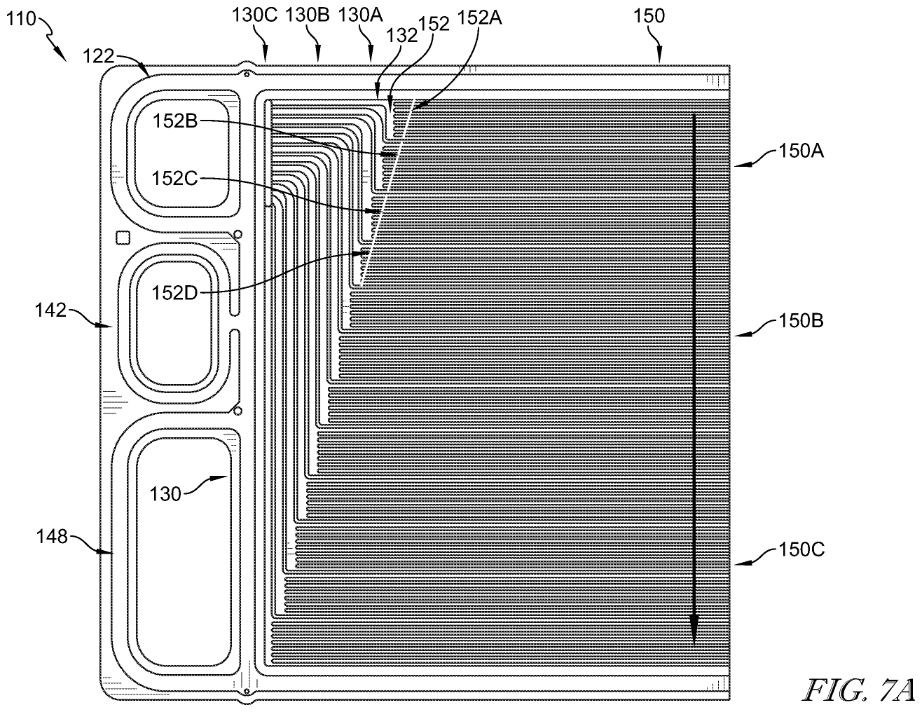

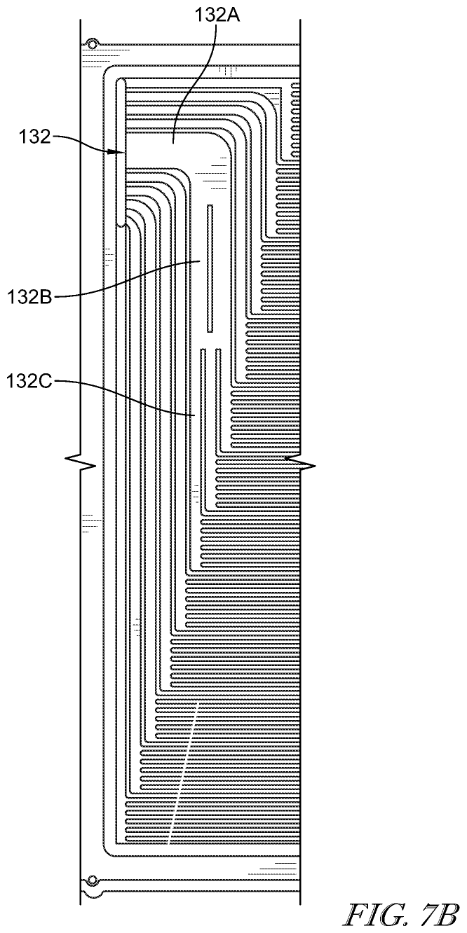

A first non-limiting example of such a variable furcation ratio of the bipolar plate 110 is shown in FIG. 7A. The bipolar plate 110 may include inlet distribution channels 132 that do not furcate, or in other words, have a furcation value of 1. As can be seen in FIG. 7A, a topmost 152A active channel 152 may furcate into seven furcated channels 158, thus defining a furcation ratio of 1:7. The next adjacent 152B active channel 152 may furcate into eight furcated channels 158, thus defining a furcation ratio of 1:8. The remaining active channels 152 may successively alternate between furcation ratios of 1:7 and 1:8. For example, the next adjacent 152C active channel 152 may furcate into seven furcated channels 158 (e.g., a furcation ratio of 1:7), the next adjacent 152D active channel 152 may furcate into eight furcated channels 158 (e.g., a furcation ratio of 1:8), and so on.

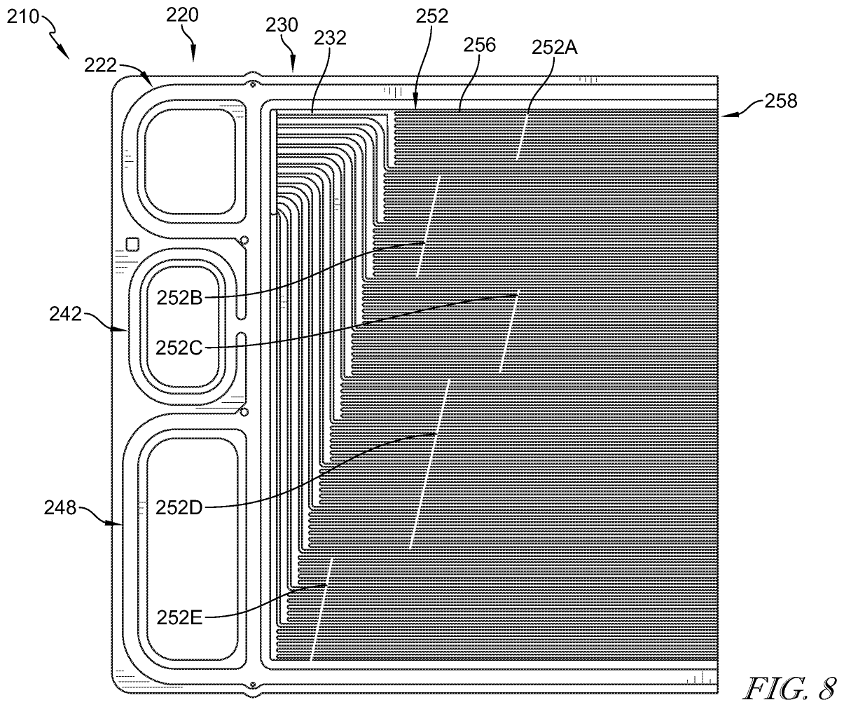

A person skilled in the art will understand that any combination of furcation ratios may be utilized based on the design requirements of the bipolar plate 110 in order to achieve a near equal pressure drop and subsequently equal mass flow distribution within the distribution channels 132, 152, 162. As described above, the furcation ratio may vary linearly, parabolically, logarithmically, monotonically, and/or any mathematical correlation along the first direction (e.g. from the top side 112 to the bottom side 114 of the bipolar plate 110 or vice versa). Additional, specific exemplary embodiments of varying furcation ratios of bipolar plate 210, 310, 410, 510 designs are described below and shown in FIGS. 8-12.

For example, in some embodiments, the furcation ratio of successive, adjacent active channels 152 may increase linearly. In some embodiments, the furcation ratio of successive, adjacent active channels 152 may increase by one (e.g. 1:1, 1:2, 1:3, 1:4, etc.) along the first direction. In some embodiments, the furcation ratio of successive, adjacent active channels 152 may increase by two (e.g. 1:2, 1:4, 1:6, 1:8, etc.) along the first direction. In some embodiments, the furcation ratio of successive, adjacent active channels 152 may increase by three (e.g. 1:3, 1:6, 1:9, 1:12, etc.) along the first direction.

In some embodiments, the furcation ratio of successive, adjacent active channels 152 may alternate by 2, instead of alternating by one as shown in FIG. 7A, (e.g. 1:6, 1:8, 1:6, 1:8, etc.) along the first direction. In some embodiments, the furcation ratio of successive, adjacent active channels 152 may alternate by three (e.g. 1:5, 1:8, 1:5, 1:8, etc.) along the first direction. In some embodiments, the furcation ratio of successive, adjacent active channels 152 may increase parabolically (e.g. 1:1, 1:2, 1:4, 1:8, etc.) along the first direction.

In some embodiments, the furcation ratio of successive, adjacent active channels 152 may increase for half of the height of the bipolar plate 110 as measured in the first direction, and then decrease for the succeeding half of the height of the bipolar plate 110. For example, the furcation ratio of successive, adjacent active channels 152 may increase linearly across the top half of the bipolar plate 110 and then decrease linearly across the bottom half of the bipolar plate 110. In some embodiments, the furcation ratio of successive, adjacent active channels 152 may increase parabolically across the top half of the bipolar plate 110 and then decrease parabolically across the bottom half of the bipolar plate 110.

In some embodiments, the furcation ratio of successive, adjacent active channels 152 may increase from 1:1 to 1:12 from the top side 112 to the bottom side 114 of the plate 110. The increase from 1:1 to 1:12 may be linear, parabolic, logarithmic, or other mathematical correlation required by the design of the bipolar plate 110. In some embodiments, the furcation ratio of successive, adjacent active channels 152 may increase from 2:1 to 2:20 from the top side 112 to the bottom side 114 of the plate 110, where the inlet distribution channels 132 furcate into two furcated channels 158. The increase from 2:1 to 2:20 may be linear, parabolic, logarithmic, or other mathematical correlation required by the design of the bipolar plate 110. In some embodiments, the increase from 2:1 to 2:20 may increase by 1 in each successive active channel 152 (e.g. 2:1, 2:2, 2:3, etc.).

In some embodiments, the furcation ratio of successive, adjacent active channels 152 may increase from 3:1 to 3:20 from the top side 112 to the bottom side 114 of the plate 110. The increase from 3:1 to 3:20 may be linear, parabolic, logarithmic, or any other mathematical correlation required by the design of the bipolar plate 110. In some embodiments, the increase from 3:1 to 3:20 may increase by one in each successive active channel 152 (e.g. 3:1, 3:2, 3:3, etc.). In some embodiments, the furcation of the inlet distribution channels 132 may increase along the length of the inlet distribution channels 132, as shown in FIG. 7B. For example, at least one channel 132 begins as a single channel 132, then furcates into two channels 132 near the middle of the channel 132, and then furcates into the three channels 132 near the transition to the active channels 152.

In some embodiments, the furcation ratio of successive, adjacent active channels 152 may increase from 3:1 to 3:20 from the top side 112 to the bottom side 114 of the plate 110. In this embodiment, the furcation of the inlet distribution channels 132 may increase along the length of the inlet distribution channels 132, e.g., the channel 132 begins as a single channel 132, the furcates into two channels 132 near the middle of the channel 132, and then furcates into the three channels 132 near the transition to the active channels 152. The increase from 3:1 to 3:20 may be linear, parabolic, logarithmic, or other mathematical correlation required by the design of the bipolar plate 110. In some embodiments, the increase from 3:1 to 3:20 may increase by 1 in each successive active channel 152 (e.g. 3:1, 3:2, 3:3, etc.).

In some embodiments, the furcation ratio of successive, adjacent active channels 152 may increase more than one time. A single inlet distribution channel 132 may furcate to multiple inlet distribution channels 132 before reaching the active area 150, as shown, for example, in FIG. 7B. Subsequently, multiple exhaust distribution channels 162 arranged at the exit 167 of the active area 150 may converge once or twice before reaching the exhaust manifold 178.

In some embodiments, the furcation of the inlet distribution channels 132 may be one to two channels 132 then furcate further to 8 active channels 152 at the inlet transition region 159 just prior to the active area 150 (e.g. 1>2:8), which may be the flow field design from the top side 112 and change similarly to the previous descriptions towards the bottom side 114 of the plate 110. In some embodiments, there may be two exhaust distribution channels 162 at the outlet transition region (e.g. region 359 in FIG. 9) from the exit 167 of the active area 150 to the exhaust distribution area 160 and then converge to a single exhaust distribution channel 162 (e.g. 8:2>1). A person skilled in the art will understand that any number of furcations may be utilized in the inlet distribution channels 132 and exhaust distribution channels 162 so long as the numbers are less than the furcation number in the active area 150.

In some embodiments, for a particular inlet distribution channel 132, the furcation ratio at the inlet transition region 159 between the inlet distribution channel 132 and the active channel 152 may not be equal to the outlet transition region (e.g. region 359 in FIG. 9) between the exit 167 of the active channel 152 and the exhaust distribution channel 162. As a non-limiting example, a single inlet distribution channel 132 may furcate to two inlet distribution channels 132 towards the plurality of active channels 152 (e.g. 1>2:8) and the exhaust distribution channels 162 may be furcated into the three exhaust distribution channels 162, then two exhaust distribution channels 162, then one exhaust distribution channel 162 as it progresses from the exit 167 of the active channel 152 to the exhaust manifold 178 (e.g. 8:3>1), which may be the flow field design from the top side 112 and change similarly to the previous descriptions towards the bottom side 114 of the plate 110. A person skilled in the art will understand that any number of furcations may be utilized in the inlet distribution channels 132 and the exhaust distribution channels 162 so long as the numbers are less than the furcation number in the active area 150.

Another embodiment of a bipolar plate 210 in accordance with the present disclosure is shown in FIG. 8. The bipolar plate 210 is substantially similar to the bipolar plate 110 described herein. Accordingly, similar reference numbers in the 200 series indicate features that are common between the bipolar plate 210 and the bipolar plate 110. The description of the bipolar plate 110 is incorporated by reference to apply to the bipolar plate 210, except in instances when it conflicts with the specific description and the drawings of the bipolar plate 210. Any combination of the components of the bipolar plate 110 and the bipolar plate 210 described in further detail below may be utilized in an assembly of the present disclosure.

Similar to the bipolar plate 110, an inlet manifold region 220 of the bipolar plate 210 can include a first manifold 222 (also referred to as a port 222), a second manifold 242, and a third manifold 248. The plate 210 can include an inlet distribution area 230 having a plurality of inlet distribution channels 232 formed similarly to the inlet distribution channels 132 described above. The exhaust distribution area (not shown) can also include a plurality of exhaust distribution channels arranged therein that are similar or identical to the inlet distribution channels 232 and similar or identical to the exhaust distribution channels 162 described above. The plate 210 can further include a plurality of active channels 252 that each extend between a corresponding inlet distribution channel 232 and exhaust distribution channel. The active channels 252 can furcate into multiple furcated channels 258 defined between furcating lands 256.

Illustratively, the bipolar plate 210 may include inlet distribution channels 232 that do not furcate, or in other words, have a furcation value of 1. As can be seen in FIG. 8, a topmost 252A active channel 252 may furcate into ten furcated channels 258, thus defining a furcation ratio of 1:10. The next two adjacent 252B active channels 252 may furcate into nine furcated channels 258, thus defining a furcation ratio of 1:9. The next two adjacent 252C active channels 252 may furcate into eight furcated channels 258, thus defining a furcation ratio of 1:8. The next four adjacent 252D active channels 252 may furcate into seven furcated channels 258, thus defining a furcation ratio of 1:7. The final three adjacent 252E active channels 252 may furcate into six furcated channels 258, thus defining a furcation ratio of 1:6.

Another embodiment of a bipolar plate 310 in accordance with the present disclosure is shown in FIG. 9. The bipolar plate 310 is substantially similar to the bipolar plates 110, 210 described herein. Accordingly, similar reference numbers in the 300 series indicate features that are common between the bipolar plate 310 and the bipolar plates 110, 210. The description of the bipolar plates 110, 210 are incorporated by reference to apply to the bipolar plate 310, except in instances when it conflicts with the specific description and the drawings of the bipolar plate 310. Any combination of the components of the bipolar plates 110, 210 and the bipolar plate 310 described in further detail below may be utilized in an assembly of the present disclosure.

Similar to the bipolar plates 110, 210, the plate 310 can include an inlet distribution area 330 having a plurality of inlet distribution channels 332 formed similarly to the inlet distribution channels 132, 232 described above. The exhaust distribution area 360 can also include a plurality of exhaust distribution channels 362 arranged therein that are similar or identical to the inlet distribution channels 332 and similar or identical to the exhaust distribution channels 162 described above. The inlet distribution channels 332 may be formed between lands 334 defining grooves 340 therebetween, and the exhaust distribution channels 362 may be formed between end lands 363 defining grooves 364 therebetween. The plate 310 can further include a plurality of active channels 352 that each extend between a corresponding inlet distribution channel 332 and exhaust distribution channel 362 through an active area 350. The active channels 352, which are formed between end lands 354, can furcate into multiple furcated channels 358 defined between furcating lands 356.

The channels 332, 352, 362 are shown in the upper illustration of the entire bipolar plate 310 of FIG. 9 as not furcated simply in order to illustrate the boundaries of the inlet distribution area 330, the active area 350, and the exhaust distribution area 360. The furcation properties of the channels 332, 352, 362 are exemplified in the magnified views of the bipolar plate 310 in the lower illustrations of FIG. 9.

Illustratively, the bipolar plate 310 may include inlet distribution channels 332 that do not furcate, or in other words, have a furcation value of 1. As can be seen in FIG. 9, the furcated channels 358 can vary between furcation ratios of 1:2, 1:3, and 1:4. For example, as shown in the magnified portion on the left of FIG. 9, the active channels 352 may successively vary between furcation ratios of 1:4, 1:3, and 1:2, as represented by 352A, 352B, and 352C, respectively. Also, as shown in the magnified portion on the right of FIG. 9, the active channels 352 may successively vary between furcation ratios of 1:2 and 1:3, as represented by 352D and 352E, respectively.

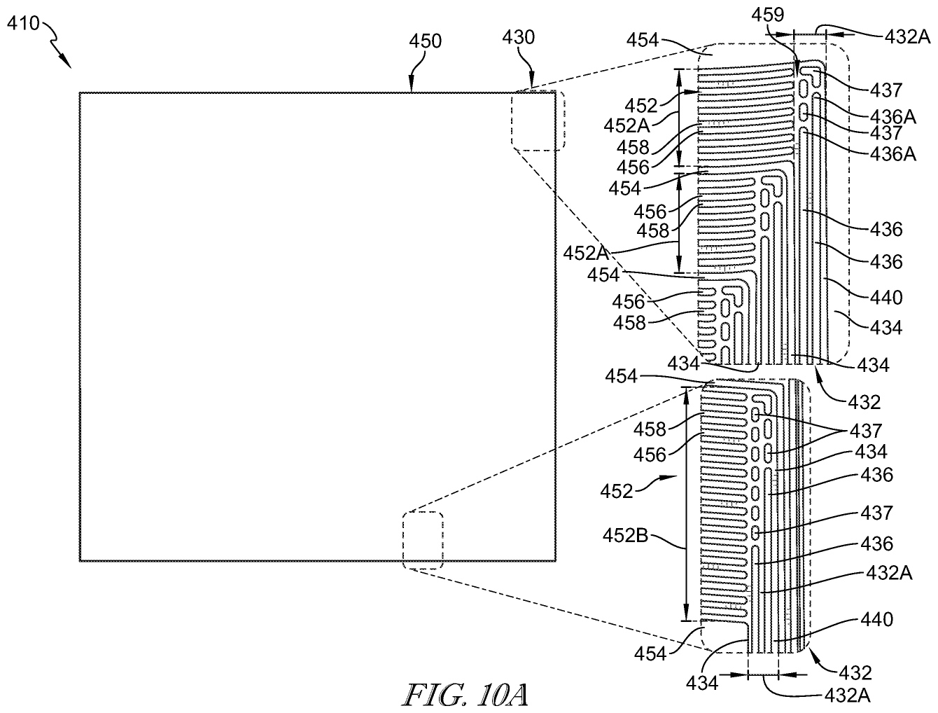

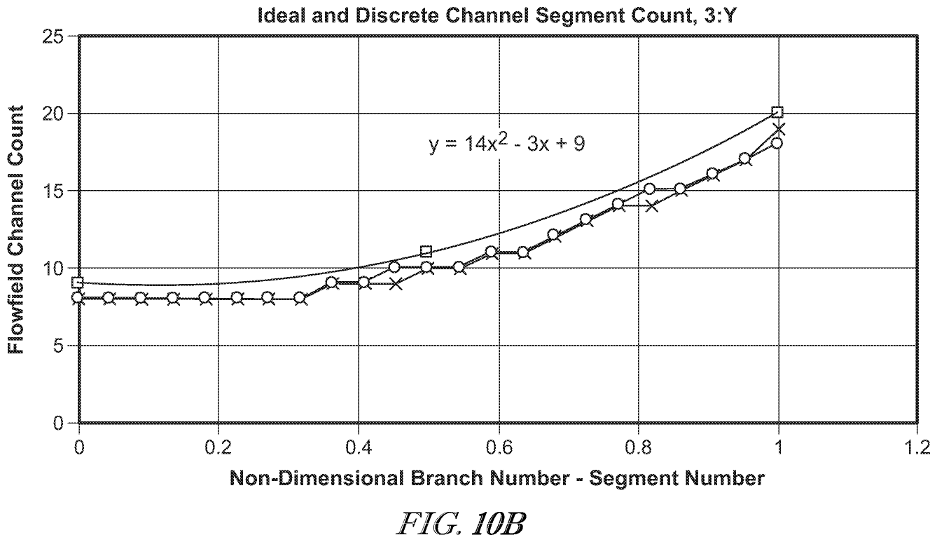

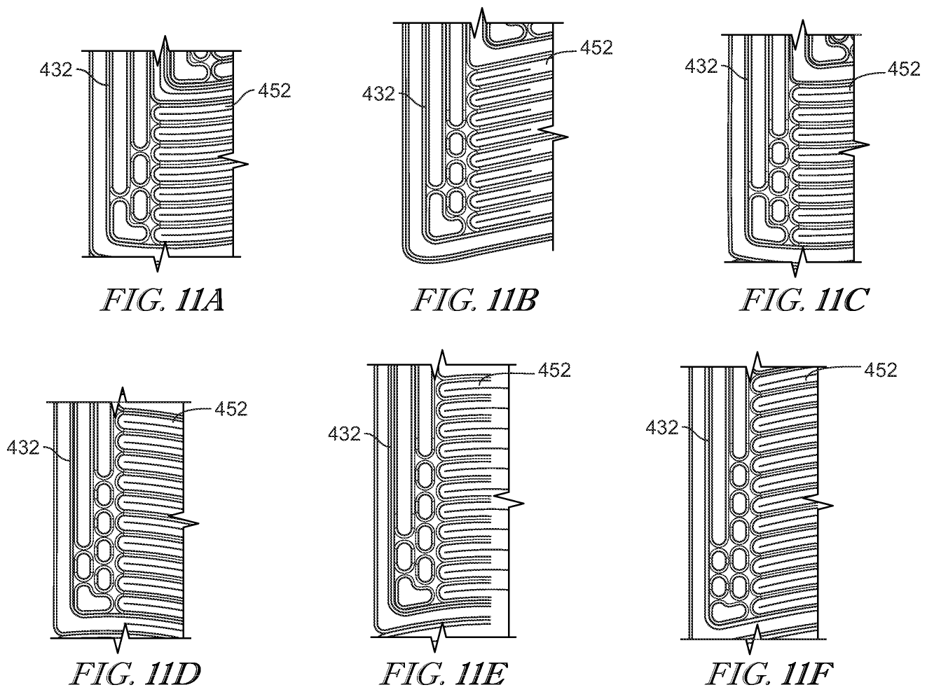

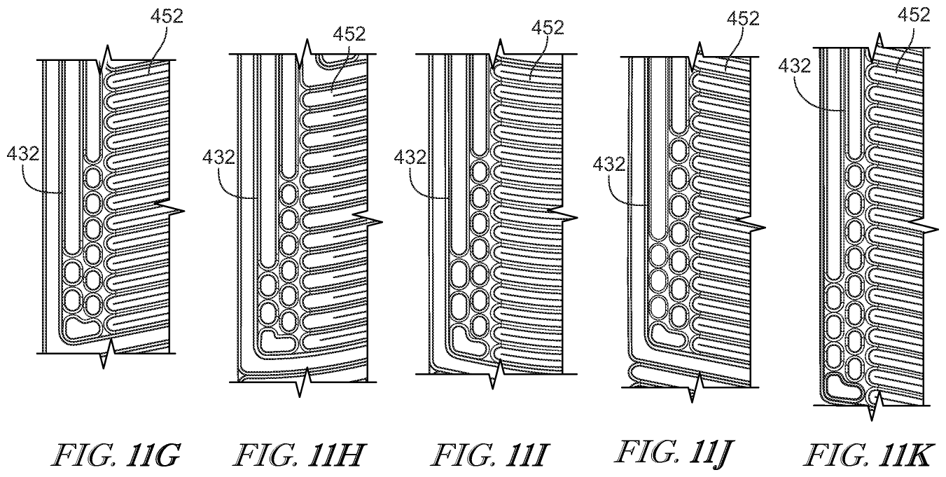

Another embodiment of a bipolar plate 410 in accordance with the present disclosure is shown in FIGS. 10A and 11A-11K. The bipolar plate 410 is substantially similar to the bipolar plates 110, 210, 310 described herein. Accordingly, similar reference numbers in the 400 series indicate features that are common between the bipolar plate 410 and the bipolar plates 110, 210, 310. The description of the bipolar plates 110, 210, 310 are incorporated by reference to apply to the bipolar plate 410, except in instances when it conflicts with the specific description and the drawings of the bipolar plate 410. Any combination of the components of the bipolar plates 110, 210, 310 and the bipolar plate 410 described in further detail below may be utilized in an assembly of the present disclosure.

Similar to the bipolar plates 110, 210, 310, the plate 410 can include an inlet distribution area 430 having a plurality of inlet distribution channels 432 formed similarly to the inlet distribution channels 132, 232, 332 described above. The exhaust distribution area (not shown) can also include a plurality of exhaust distribution channels arranged therein that are similar or identical to the inlet distribution channels 432 and similar or identical to the exhaust distribution channels 162 described above. The plate 410 can further include a plurality of active channels 452 in an active area 450 that each extend between a corresponding inlet distribution channel 432 and exhaust distribution channel.

Although the active area 450 is illustrated as blank, the active area 450 and the active channels 452 formed therein can be similarly formed to active channels 152, 252, 352 described above, in particular furcating into individual, parallel channels that run from the distribution area 430 to the exhaust distribution area. The active channels 452 can furcate into multiple furcated channels 458 defined between furcating lands 456. Moreover, unlike the inlet distribution channels 132, 232, 332, the inlet distribution channels 432 may also furcate into multiple furcated channels 440 defined between elongated lands 436.

FIG. 10A shows that the bipolar plate 410 may include inlet distribution channels 432 that furcate into three furcated channels 440, or in other words, have a furcation value of 3. A person skilled in the art will understand that the inlet distribution channels 432 may furcate into other numbers of furcated channels 440 in other embodiments. As can be seen in FIG. 10A, the two topmost 452A active channels 452 may furcate into eight furcated channels 458, thus defining a furcation ratio of 3:8. As illustrated, the two topmost 452A active channels 452 are located furthest from the inlet manifold (although not illustrated, the inlet manifold would be located in the lower-right corner of the bipolar plate 410 when viewing FIG. 10A). The active channels 452 are defined between end protrusions 454, or end lands 454. The plurality of inlet distribution channels 432 are formed between elongated protrusions 434, or lands 434.

In some embodiments, the inlet transition region 459 between the inlet distribution channels 432 and the active channels 452 may include island lands 437 arranged adjacent to a terminal end 436A of one of the elongated lands 436. For example, the island lands 437 are aligned with at least one of the elongated lands 436, and in some embodiments, aligned with an innermost elongated land 436. The island lands 437 can serve to aid in uniform compression of the gas diffusion layers 24, 26 on the bipolar plate 410, which will cause even pressure distribution and even contact with the gas diffusion layers 24, 26. In some embodiments, the inlet distribution channel 432 can include two island lands 437 aligned with the innermost elongated land 436.

As can also be seen in FIG. 10A, the bottommost 452B active channels 452 may furcate into nineteen furcated channels 458, thus defining a furcation ratio of 3:19. As illustrated, the two bottommost 452B active channels 452 are located closest to the inlet manifold (although not illustrated, the inlet manifold would be located in the lower-right corner of the bipolar plate 410 when viewing FIG. 10A).

In some embodiments, the inlet transition region 459 between the inlet distribution channels 432 and the active channels 452 near the inlet manifold may include additional island lands 437 that are aligned with at least one of the elongated lands 436. In some embodiments, the inlet distribution channel 432 includes island lands 437 arranged in the inlet transition region 459 that are aligned with an innermost elongated land 436 and island lands 437 arranged in the inlet transition region 459 that are aligned with an outermost elongated land 436, as shown in FIG. 10A. In some embodiments, the inlet distribution channel 432 can include two island lands 437 aligned with the outermost elongated land 436, and seven island lands 437 aligned with the innermost elongated land 436.

The active channels 452 between the two topmost 452A active channels 452 defining a furcation ratio of 3:8 and the bottommost 452B active channel 452 defining a furcation ratio of 3:19 may increase from a furcation ratio of 3:8 to 3:19 in variety of manners. Illustratively, the increase is parabolic. In particular, FIG. 10B shows a parabolic relationship of the active channels 452, with the x-axis representing channel location relative to the inlet manifold (0 being further from the inlet manifold, e.g. the topmost 452A active channels 452, and 1 being closest to the inlet manifold, e.g. the bottommost 452B active channels 452), and the y-axis representing furcation count.

In some embodiments, as shown in FIGS. 11A-11K, the number of active channels 452 may increase from the top side of the plate 410 to the bottom side of the plate 410 in the progression shown from the furcation ratio of FIG. 11A, corresponding to a topmost part of the plate 410, through the furcation ratio of FIG. 11K, corresponding to a bottommost part of the plate 410. Specifically, the number of inlet distribution channels 432 may remain furcated to 3, while the number of active channels 452 increases from the ratios shown in FIGS. 11A-11K shown by 8, 9, 9, 11, 12, 13, 14, 14, 16, 17, 19. Moreover, the number of island lands 437 located in the inlet distribution channel 432 can increase along the ratios shown in FIGS. 11A-11K.

For example, in the land 436 closest to the active channels 452, the number of island lands 437 increases from 2, 3, 3, 4, 4, 5, 6, 6, 7, 7, 8 along the ratios shown in FIGS. 11A-11K. In the land 436 adjacent to the previous land 436, the number of island lands 437 increases from 0, 0, 0, 1, 1, 2, 2, 2, 2, 3, 3 along the ratios shown in FIGS. 11A-11K. A person skilled in the art will understand that the measurements and ratios shown in FIGS. 11A-11K are not limiting to possible measurements and ratios of this or other progressions of furcation ratios of the plate 410, including from which of the top and bottom sides of the plate 410 the ratios progress from. Moreover, a person skilled in the art will understand that the increase could be linear, logarithmic, or any other mathematical correlation required by the design of the bipolar plate 410.

Table 2 below shows results of a similar analysis to that which was performed regarding FIG. 4 and as shown in Table 1. In particular, Table 2 shows pressure and stoich estimates for the similar path lengths through the bipolar plate 410 (e.g. similar to Paths A, B, and C of FIG. 4). In this case, the results were for a parabolic furcation change:

TABLE 2

| Path | dP_kPa | Stoich |
|---|---|---|
| 1. | 19.45 | 1.38 |
| 2. | 18.99 | 1.41 |
| 3. | 18.95 | 1.41 |

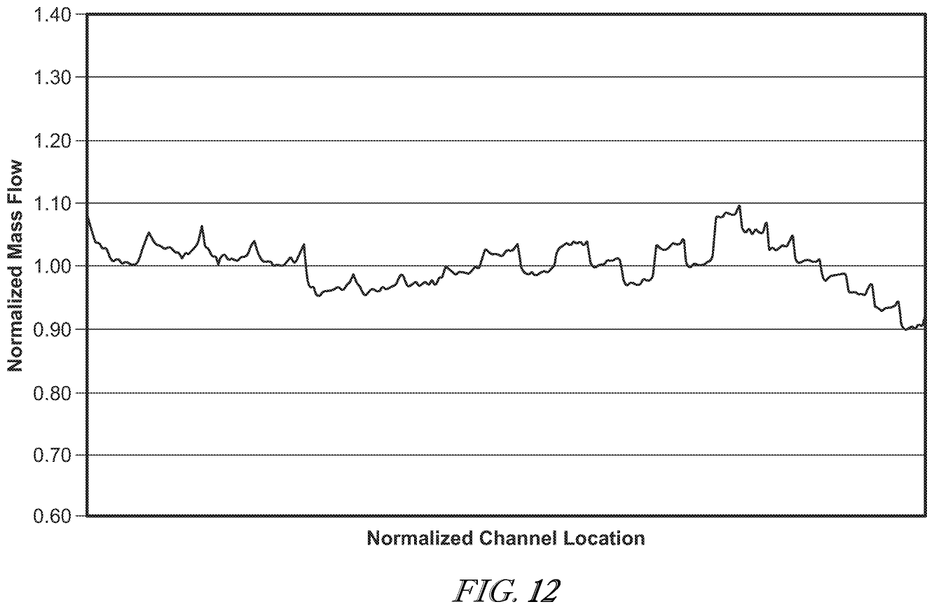

Moreover, FIG. 12 shows CFD analysis results for the parabolic furcation change of the bipolar plate 410 described above. As can be seen in FIG. 12, the parabolic furcation change resulted in a +/−10% variance from the normalized target having a stoich of approximately 1.4 along all pathways, which is a significant improvement over the results shown in Table 1 with reference to the bipolar plate 110 design shown in FIG. 4.

The varying furcation ratios of the bipolar plates 110, 210, 310, 410, 510, 610, 710, 810, 810′ described in the various embodiments herein contribute to achieving symmetric pressure drop by shifting the consumption responsible of each branch, or channel path A, B, C, to achieve a near equal pressure drop and subsequently equal mass flow distribution within the flow channels. Another aspect of the bipolar plate 110, 210, 310, 410, 510, 610, 710, 810, 810′ that can be designed to optimize the pressure drop and mass flow distribution within the flow channels is the geometry of the flow channels, in particular the lands and grooves of the inlet distribution channels, as well as the lands and grooves that form the flow channels of the exhaust distribution area.

As described above, the result of reactant 32, 34 present on either side of the flow fields of the bipolar plate 110, in particular in the active area 150, is voltage. However the fuel cell 20 must supply voltage and current to provide power, as the electrical equation for power of a single fuel cell 20 is P_{electric,cell}=V_{cell}*A, where (V) is cell 20 voltage and (A) is cell 20 current. The same equation is true for the fuel cell stack 12. The number of cells 20 is also proportionally included in this equation: P_{electric,stack}=(V_{cell}*N_{cells})*A.

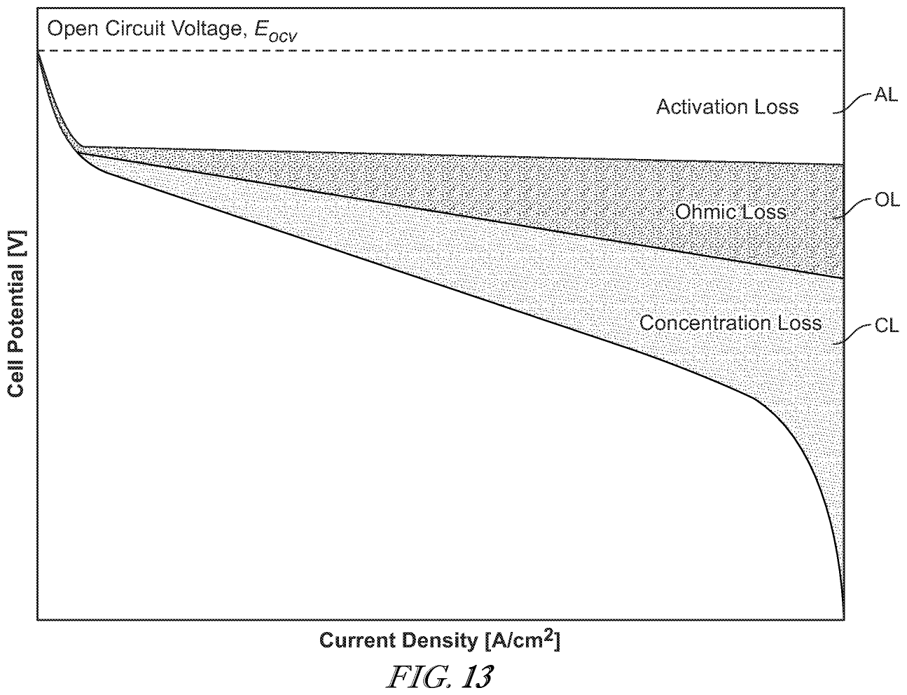

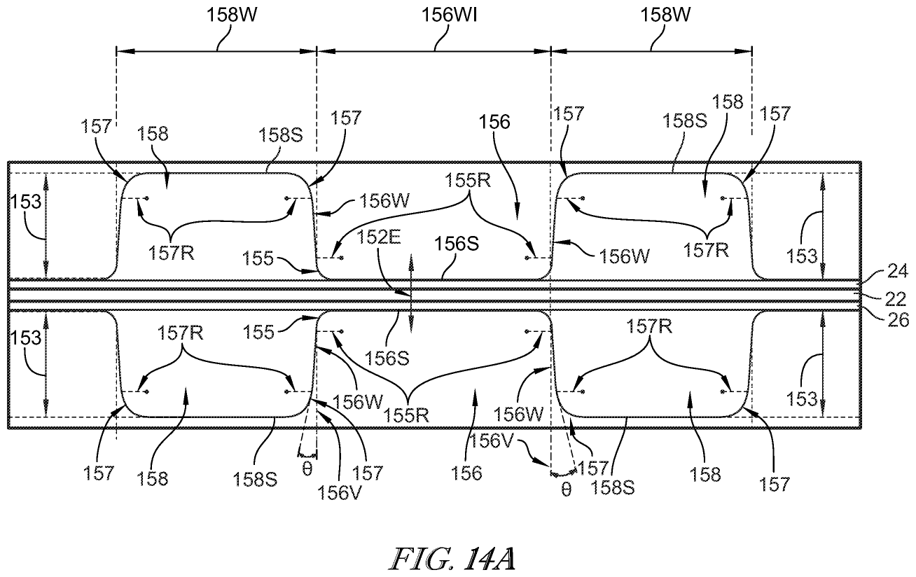

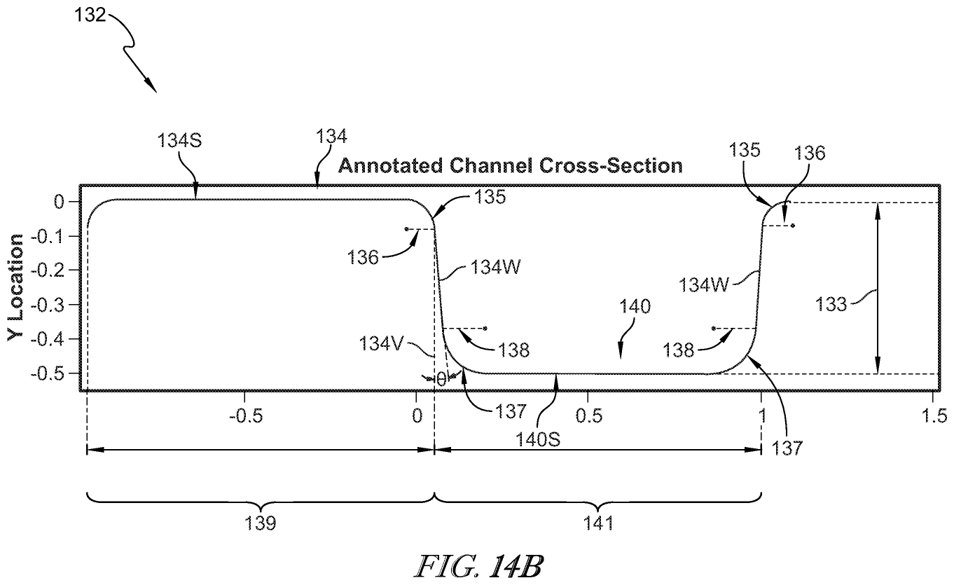

On a single cell level, the voltage response as a function of current can be seen in FIG. 13, which shows a PEM fuel cell polarization (POL) curve with highlighted losses. The x-axis is current density, or area specific current, which can be interpreted as how hard the cell 20 is being run independent of its size. The y-axis is the voltage response from the minimum current of zero, to the maximum current. Typically, this voltage-current relationship can be called a POL curve. Also included in FIG. 13 is the losses that always accompany the increase in cell 20 current, which are activation losses AL, ohmic losses OL, and concentration losses CL.

Activation losses AL are losses associated with electrochemical conversion kinetics. Activation losses are a function of the MEA 22 and catalyst composition. Ohmic losses OL are considered the resistive losses through the series electrical pathway; the MEA 22 layer through the layer formed by the gas diffusion layers 24, 26 and the bipolar plate 110. Activation losses are analogous to an equivalent electrical resistor. The variance in ohmic losses is linear with respect to current.

Concentration losses CL are considered the diffusion latency loss between the active channels 152 and the MEA 22, through the gas diffusion layers 24, 26 and into the catalyst on the MEA 22. Concentration losses can be approximated as linear, similar to the ohmic losses, until the higher current density region of the POL curve. At the higher region, the concentration losses start to increase drastically. The higher region is called concentration polarization and should be avoided in customer operation to ensure long-life form the system 10.

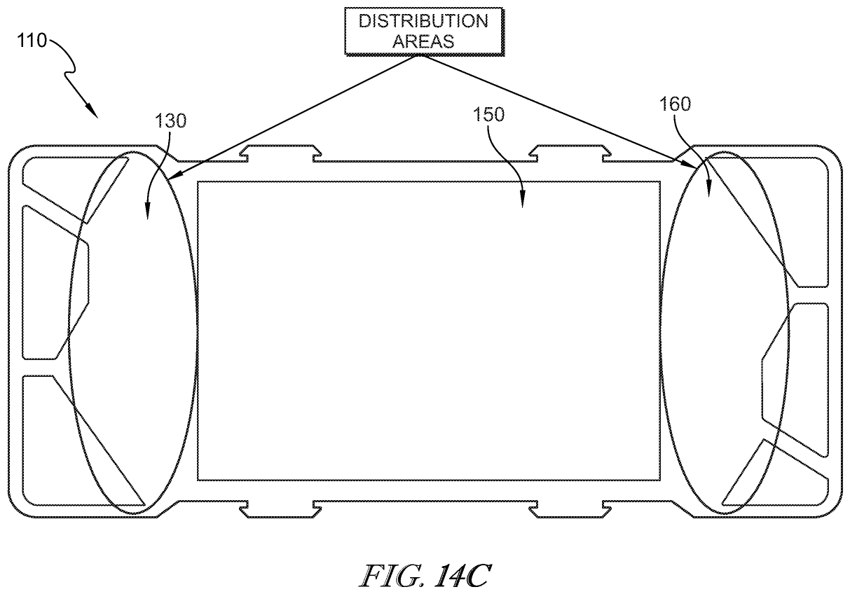

Illustratively, the land and the groove dimensions are the linear dimensions that govern the amount of the gas diffusion layers 24, 26 that is in contact with the bipolar plate 110 and the width left over for the reactant flow. Referring back to the bipolar plate 110 described above, the land surface 156S of each active channel 152 furcating land 156 touches the corresponding gas diffusion layer 24, 26 and electrons pass along the electron path 152E between the lower land 156 and the upper land 156, as shown in FIG. 14A. An increase in the land width leads to an increase in the diffusion path length defined at least in part by the electron path 152E.

FIG. 14A shows typical manufacturing dimensional features that an active flow field channel 152 can possess to operate. Each active channel 152, or in this case, furcated channel 158, includes a land surface 156S on a top side of the land 156, a land wall 156W extending downwardly from the land surface 156S into the furcated channel 158, or groove 158, toward a bottom groove surface 158S of the groove 158 formed between adjacent lands 156. A first fillet 155 is formed between the land surface 156S and the land wall 156W. A second fillet 157 is formed between the land wall 156W and the bottom groove surface 158S.

The active channel 152 has a height 153 defined vertically between the land surface 156S and the bottom groove surface 158S. The first fillet 155 has a first fillet radius 155R. The second fillet 157 has a second fillet radius 157R. The land 156 has a land width 156WI. The groove 158 has a groove width 158W. In some embodiments, the land width 156WI may be measured between a transition point between the land wall 156W and the first fillet 155 and the same transition point on the opposing side of the land 156, as shown in FIG. 14A. The groove 158, or furcated channel 158, width 158W may be measured between these transition points, but across the groove 158 instead of across the land 156.

In some embodiments, the first and second fillet radii 155R, 157R aid in avoiding material breakage or avoid splitting of the metal sheet 192, 196. The angle formed between an imaginary vertical plane 156V and the land wall 156W is a draft angle θ of the furcated channel 158 which, in some embodiments, ensures that the sheet 192, 196 can be released from a forming die. The heights, widths, radii, and draft angles described above all exist for both graphite and metallic substrates, albeit with slightly different values.

The term “land fraction” (L_{f}) can be used to describe the ratio of land-to-groove and can be described in Equation 3:

$${L}_{f} = \frac{{L}_{land}}{{L}_{land} + {L}_{groove}} = \frac{{L}_{land}}{{L}_{total width}} \qquad ( 3 )$$

The variable L_{land} represents the length of the land (e.g. land width 139, 156WI), and the variable L_{groove} represents the length of the groove (e.g. groove width 141, 158W). The sum of the land and the groove widths is equal to the total width L_{total width} of the repeating flow field channel that characterizes one of many channels 132, 152, 162 within the flow fields.

Physically, the land 156 and the groove 158 represent very important functions of the flow field. The width 156WI of the land 156 is responsible for two primary functions. Firstly, the land width 156WI enables electrical contact, as this is an important contact point along the physical path that electrons must travel, in particular the lands 156 of the active channels 152 in the active area 150. A wide land 156 reduces the electrical resistance and therefore can reduce losses within the fuel cell system 10. A narrow land 156 may produce a system 10 where the electrical contact is too small to efficiently pass current through the plate 110.

In some embodiments, the land and groove widths 156WI, 158W can be in a range of about 0.5 mm to about 2.5 mm, including any specific number or range of numbers comprised therein. In some embodiments, the “land fraction” (L_{f}) of the active channel 152 can range from about 0.25 to about 0.75, including any specific number or range of numbers comprised therein.

Secondly, the land width 156WI also controls the diffusion path length from the channel 158 to the MEA 22 over the land 156, in particular the land widths 156WI of the lands 156 in the active area 150. Because the land 156 does not have active fluid like the groove (furcated channels 158 or active channel 152), the path length from the MEA 22 over the land 156 in now increased as the fluid would need to diffuse both vertically and horizontally. In some applications, having a wide land 156 can also increase diffusion resistance to and from the MEA 22. Subsequently, if the land 156 is too narrow, the diffusion may be too aggressive and dry the cell 20.

FIG. 14B shows the land 134 and groove 140 geometries of the inlet distribution area 130, which is also applicable to similar or identical land and groove geometries formed in the exhaust distribution area 160. The inlet and exhaust distribution channels 132, 162 formed in the distribution areas 130, 160 may be referred to as “non-conductive channels” because the distribution channels 132, 162 possess land widths that are likely too short to efficiently facilitate electrical conductivity. Each distribution channel 132 includes a land surface 134S on a top side of the land 134, a land wall 134W extending downwardly from the land surface 134S into the distribution channel 132 toward a bottom groove surface 140S of the groove 140 formed between adjacent lands 134.

The distribution channel 132 can include a first fillet 135 formed between the land surface 134S and the land wall 134W, and a second fillet 137 formed between the land wall 134W and the bottom groove surface 140S. In some embodiments, the land width 139 may be measured between a transition point between the land wall 134W and the first fillet 135 and the same transition point on the opposing side of the land 134, as shown in FIG. 14B. The groove width 141 may be measured between these transition points, but across the groove 140 instead of across the land 134.

The distribution channel 132 has a height 133 defined vertically between the land surface 134S and the bottom groove surface 140S. The first fillet 135 has a first fillet radius 136. The second fillet 137 has a second fillet radius 138. In some embodiments, the first and second fillet radii 136, 138 aid in avoiding material breakage or avoid splitting of the metal sheet 192, 196. The angle formed between an imaginary vertical plane 134V and the land wall 134W is a draft angle θ of the distribution channel 132 which, in some embodiments, ensures that the sheet 192, 196 can be released from a forming die. The heights, widths, radii, and draft angles described above all exist for both graphite and metallic substrates, albeit with slightly different values.

By way of a non-limiting example, Table 3 below shows exemplary ranges of the first and second fillet radii 136, 138, the draft angle θ, and the height 133:

TABLE 3

| | Minimum | | Maximum | |
|---|---|---|---|---|
| Feature | Value | | Value | |
| First fillet radius 136 | 0.05 | mm | 0.3 | mm |
| Second fillet radius 138 | 0.1 | mm | 0.4 | mm |
| Draft angle θ | 5 | degrees | 45 | degrees |
| Height 133 | 0.15 | mm | 0.6 | mm |

A person skilled in the art will understand that the above ranges are only exemplary, and that other values may be utilized in other embodiments of the bipolar plates 110, 210, 310, 410, 510, 610, 710, 810, 810′ described herein and any alternatives thereto.

The grooves 140, 158, 168 are responsible for fluid flow of the reactants 32, 34. A wide groove 140, 158, 168 with respect to the corresponding land 134, 156, 166, or in other words, a small land fraction, enables a lower pressure-drop in the channels 132, 152, 162. Taking pressure drop into account, as described above, the following considerations must be accounted for when designing channels 132, 152, 162 for efficient operation: (i) a land fraction that enables adequate electrical continuity, (ii) a land fraction that enables sufficient diffusion for reactants 32, 34 and subsequently sufficient diffusion resistance to keep the cell 20 hydrated, and (iii) a land fraction that enables a wide enough channel 132, 152, 162 for a reasonable pressure drop.

In order to satisfy the above considerations and provide a nearly uniform pressure drop and mass flow distribution, the land widths 139 in the distribution areas 130, 160 can be reduced. In other words, the distribution channels 132 may have a reduced land fraction (L_{f}). As described above, the distribution areas 130, 160 of the bipolar plate 110 are responsible for diffusing and collecting the reactants 32, 34 and products, respectively, over the active area 150, or in other words, directing and removing the reactants 32, 34 and products to and from the active area 150. Reducing the land width 139 will retain the pressure drop of the reactant pathway but severely reduce the electrical conduction width. However, in some designs the distribution areas 130, 160 may be outside of the active area 150.

Until now, the function of the land fraction has been described in two discrete locations of the bipolar plate 110. Firstly, the land fraction has been described in the active area 150, where the land fraction must be balanced to simultaneously enable adequate diffusion, conduction, and fluidic restriction. Secondly, the land fraction has been described in areas that may not be active, where the land fractions may be reduced in the absence of electrical current capacity requirements. In either case, the land width 139, 156WI was kept within its own right. However, unique cases can be made to locally vary the land width 139, 156WI to further tailor reactant 32, 34 and/or coolant 36 distribution. Reducing the land width 139, 156WI would lower the hydraulic diameter and increase the velocity, both of which contribute to an increase of pressure drop in that section of the active channel 152. This concept can be used in conjunction with the other methods described herein.

With this assumption as an example, and because the distribution channels 132, 162 are non-conductive channels, the change to the land width 139 is inconsequential to the function of the bipolar plate 110. Non active flow channels may be utilized to adequately ensure distribution to the desired sections of the active area 150. Often times, as a consequence of ensuring sufficient distribution, sections of the bipolar plate 110 may be obscure, and difficult to cover with the MEA 22 (and gas diffusion layers 24, 26).

Most MEA 22 designs are chosen to be square or rectangular for economic reasons, as can be seen in FIG. 14C. In the sections outside of the active area 150, reducing the conductivity of the channels 132, 162 will make for a narrower channel 132, 162 and thus a more compact design. Reducing the area outside of the active area 150, while maintaining active area function, makes for a more compact overall bipolar plate design and a higher spatial utilization. Utilization can be regarded with the following Equation 4:

$$Utilization = \frac{Active Area}{Total BPP 2 D Area} \qquad ( 4 )$$

The utilization criteria can be used to quantify the compactness of a bipolar plate design, which drastically contributes to stack power density. The goal of a designer is to reduce the excessive space used to fluidically couple the active area 150 of the bipolar plate to the manifolds 122, 142, 148, 172, 174, 178, as well as design the shape and size of the manifolds 122, 142, 148, 172, 174, 178 to minimum size that achieves robust functionality. Thus, making narrow land widths an attractive feature where electrical conductivity is not required.

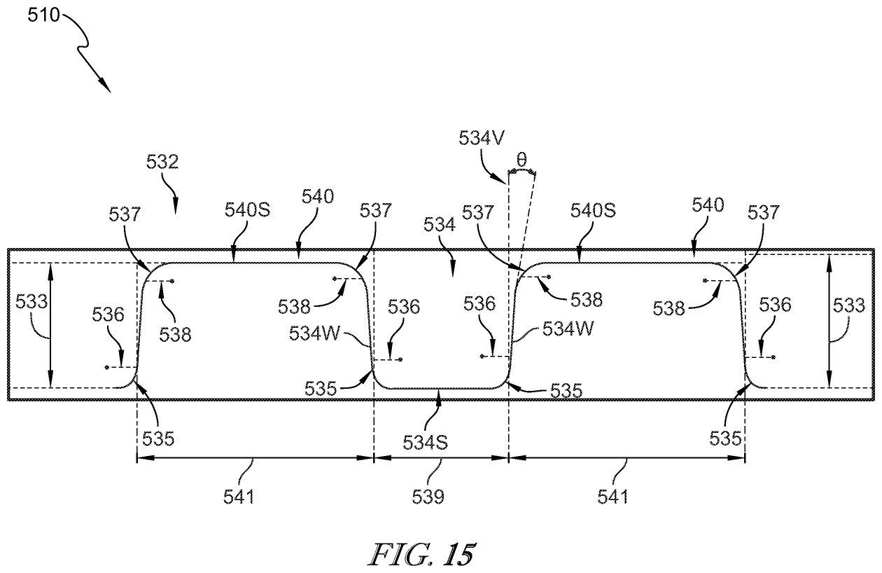

An exemplary embodiment of a bipolar plate 510 having a reduced land width channel geometry is shown in FIG. 15. The bipolar plate 510 is substantially similar to the bipolar plates 110, 210, 310, 410. Accordingly, similar reference numbers in the 500 series indicate features that are common between the bipolar plate 510 and the bipolar plates 110, 210, 310, 410. The description of the bipolar plates 110, 210, 310, 410 are incorporated by reference to apply to the bipolar plate 510, except in instances when it conflicts with the specific description and the drawings of the bipolar plate 510. Any combination of the components of the bipolar plates 110, 210, 310, 410 and the bipolar plate 510 described in further detail below may be utilized in an assembly of the present disclosure.

Similar to the inlet distribution channels 132 described above, each inlet distribution channel 532 includes a land surface 534S on a top side of the land 534, a land wall 534W extending downwardly from the land surface 534S into the inlet distribution channel 532 toward a bottom groove surface 540S of the groove 540 formed between adjacent lands 534. The inlet distribution channel 532 includes a first fillet 535 formed between the land surface 534S and the land wall 534W, and a second fillet 537 formed between the land wall 534W and the bottom groove surface 540S.

The inlet distribution channel 532 has a height 533 defined vertically between the land surface 534S and the bottom groove surface 540S. The first fillet 535 has a first fillet radius 536. The second fillet 537 has a second fillet radius 538. The land 534 has a land width 539. The groove 540 has a groove width 541. In some embodiments, the first and second fillet radii 536, 538 aid in avoiding material breakage or avoid splitting of the metal sheet 192, 196. The angle formed between an imaginary vertical plane 534V and the land wall 534W is a draft angle θ of the inlet distribution channel 532 which, in some embodiments, ensures that the sheet 192, 196 can be released from a forming die. These values all exist for both graphite and metallic substrates, albeit with slightly different values.

Illustratively, the land width 539 may be approximately half of the groove width 541. In some embodiments, the land width 539 is exactly half of the groove width 541. In one non-limiting example, the land width 539 may be equal to 0.5 mm and the groove width 541 may be equal to 1.0 mm. As such, the “land fraction” (L_{f}) of the channel 532 according to Equation 3 would be equal to 0.3333 repeating.

In some embodiments, the widths 539, 541, as located in the inlet or exhaust distribution regions, can be in a range of 0.01 mm to 2.5 mm, including any specific number or range of numbers comprised therein. In some embodiments, the “land fraction” (L_{f}) can range from 0.05 to 0.75, including any specific number or range of numbers comprised therein. In some embodiments, the “land fraction” (L_{f}) can range from 0.05 to 0.5, including any specific number or range of numbers comprised therein. In some embodiments, the “land fraction” (L_{f}) can be equal to or below 0.5. In some embodiments, the “land fraction” (L_{f}) can be equal to or below 0.4. In some embodiments, the “land fraction” (L_{f}) can be equal to or below 0.3. In some embodiments, the “land fraction” (L_{f}) can be equal to or below 0.2. In some embodiments, the “land fraction” (L_{f}) can be equal to or below 0.1. In some embodiments, the “land fraction” (L_{f}) can be equal to or below 0.05. In some embodiments, the “land fraction” (L_{f}) can be equal to or below 0.01.

For example, in some embodiments, the land width 539 may be equal to 0.75 mm and the groove width 541 may be equal to 1.5 mm. In some embodiments, the land width 539 may be equal to 1.0 mm and the groove width 541 may be equal to 2.0 mm. In some embodiments, the land width 539 may be equal to approximately 40% of the groove width 541. In some embodiments, the land width 539 may be equal to approximately 60% of the groove width 541. In some embodiments, the land width 539 may be in a range of approximately 30-70% of the groove width 541, including any specific number or range of numbers comprised therein. In some embodiments, the land width 539 may be in a range of approximately 20-80% of the groove width 541, including any specific number or range of numbers comprised therein. In some embodiments, the land width 539 may be in a range of approximately 10-90% of the groove width 541, including any specific number or range of numbers comprised therein. In some embodiments, the land width 539 may be in a range of approximately 1-99% of the groove width 541, including any specific number or range of numbers comprised therein, so long as the land width 539 is smaller than the total width.

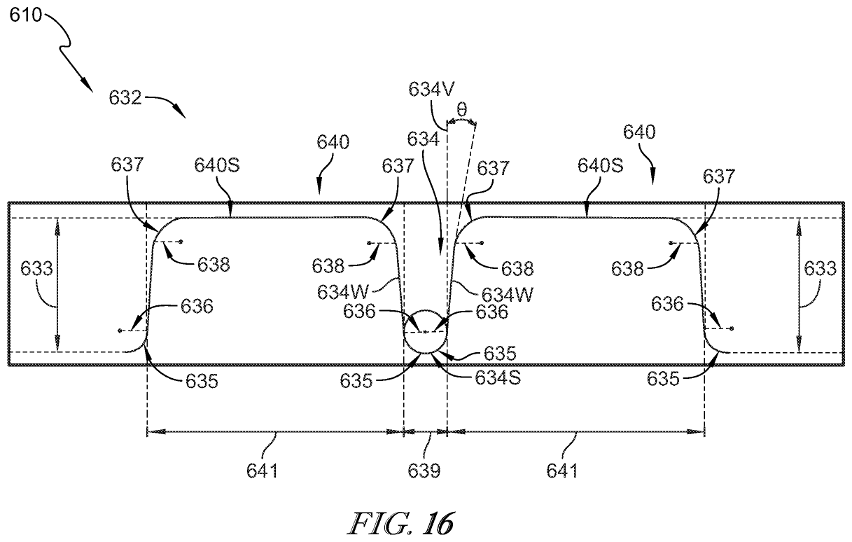

Another embodiment of a bipolar plate 610 in accordance with the present disclosure is shown in FIG. 16. The bipolar plate 610 is substantially similar to the bipolar plate 510 described herein with respect to the channel geometry, as well as to bipolar plates 110, 210, 310, 410 in additional respects. Accordingly, similar reference numbers in the 600 series indicate features that are common between the bipolar plate 610 and the bipolar plates 110, 210, 310, 410, 510. The description of the bipolar plates 110, 210, 310, 410, 510 are incorporated by reference to apply to the bipolar plate 610, except in instances when it conflicts with the specific description and the drawings of the bipolar plate 610. Any combination of the components of the bipolar plates 110, 210, 310, 410, 510 and the bipolar plate 610 described in further detail below may be utilized in an assembly of the present disclosure.

Similar to the inlet distribution channels 132, 532 described above, each inlet distribution channel 632 includes a land surface 634S on a top side of the land 634, a land wall 634W extending downwardly from the land surface 634S into the inlet distribution channel 632 toward a bottom groove surface 640S of the groove 640 formed between adjacent lands 634. The inlet distribution channel 632 includes a first fillet 635 formed between the land surface 634S and the land wall 634W and a second fillet 637 formed between the land wall 634W and the bottom groove surface 640S.

The inlet distribution channel 632 has a height 633 defined vertically between the land surface 634S and the bottom groove surface 640S. The first fillet 635 has a first fillet radius 636. The second fillet 637 has a second fillet radius 638. The land 634 has a land width 639. The groove 640 has a groove width 641. In some embodiments, the first and second fillet radii 636, 638 aid in avoiding material breakage or avoid splitting of the metal sheet 192, 196. The angle formed between an imaginary vertical plane 634V and the land wall 634W is a draft angle θ of the inlet distribution channel 632 which, in some embodiments, ensures that the sheet 192, 196 can be released from a forming die. These values all exist for both graphite and metallic substrates, albeit with slightly different values.

Illustratively, the land width 639 may be approximately one tenth of the groove width 641. In some embodiments, the land width 639 is exactly one tenth of the groove width 641. For example, the land width 639 may be equal to 0.1 mm and the groove width 641 may be equal to 1.0 mm. As such, the “land fraction” (L_{f}) of the channel 632 according to Equation 3 would be equal to 0.090909 repeating.

In some embodiments, the widths 639, 641 can be in a range of 0.01 mm to 2.5 mm, including any specific number or range of numbers comprised therein. In some embodiments, the “land fraction” (L_{f}) can range from 0.01 to 0.2, including any specific number or range of numbers comprised therein. In some embodiments, the “land fraction” (L_{f}) can range from 0.01 to 0.1, including any specific number or range of numbers comprised therein. For example, in some embodiments, the land width 639 may be equal to 0.1 mm and the groove width 641 may be equal to 1.0 mm. In some embodiments, the land width 639 may be equal to 0.1 mm and the groove width 641 may be equal to 0.5 mm. In some embodiments, the land width 639 may be equal to 0.01 mm and the groove width 641 may be equal to 0.5 mm. In some embodiments, the land width 639 may be equal to approximately 10% of the groove width 641. In some embodiments, the land width 639 may be equal to approximately 30% of the groove width 641. In some embodiments, the land width 639 may be in a range of approximately 1-40% of the groove width 641, including any specific number or range of numbers comprised therein. In some embodiments, the land width 639 may be in a range of approximately 0.1-40% of the groove width 641, including any specific number or range of numbers comprised therein, so long as the land width 639 is smaller than the total width.

A person skilled in the art will understand that other land fraction values may be utilized in other bipolar plate embodiments according to the design requirements of the bipolar plate. For example, the land fraction value may be in a range of 0.01 to 0.4, including any specific number or range of numbers comprised therein. In some embodiments, the land fraction value may be in a range of 0.01 to 0.3, including any specific number or range of numbers comprised therein. In some embodiments, the land fraction value may be in a range of 0.01 to 0.2, including any specific number or range of numbers comprised therein. In some embodiments, the land fraction value may be in a range of 0.01 to 0.1, including any specific number or range of numbers comprised therein.

In some embodiments, the land fraction value may be in a range of 0.1 to 0.4, including any specific number or range of numbers comprised therein. In some embodiments, the land fraction value may be in a range of 0.1 to 0.3, including any specific number or range of numbers comprised therein. In some embodiments, the land fraction value may be in a range of 0.1 to 0.2, including any specific number or range of numbers comprised therein. In some embodiments, the land fraction value may be in a range of 0.2 to 0.4, including any specific number or range of numbers comprised therein. In some embodiments, the land fraction value may be in a range of 0.2 to 0.3, including any specific number or range of numbers comprised therein. In some embodiments, the land fraction value may be in a range of 0.3 to 0.4, including any specific number or range of numbers comprised therein.

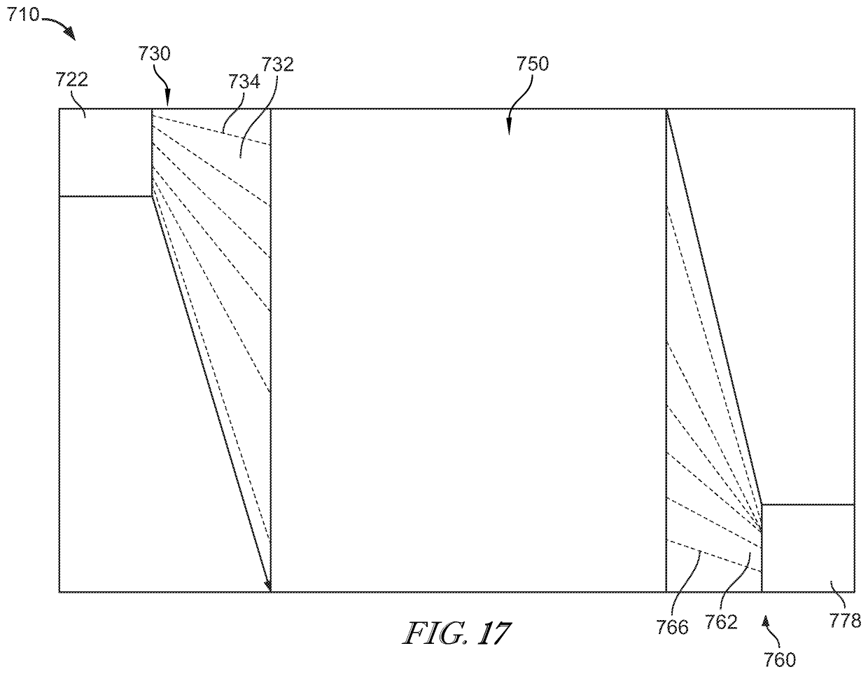

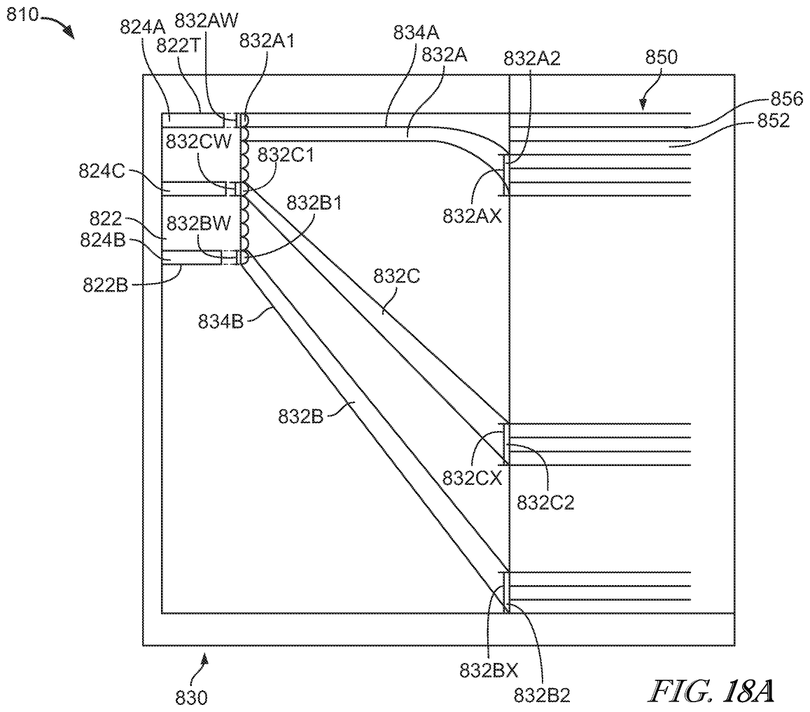

Another embodiment of a bipolar plate 710 in accordance with the present disclosure is shown in FIG. 17. The bipolar plate 710 is substantially similar to the bipolar plates 110, 210, 310, 410, 510, 610 described herein. Accordingly, similar reference numbers in the 700 series indicate features that are common between the bipolar plate 710 and the bipolar plates 110, 210, 310, 410, 510, 610. The description of the bipolar plates 110, 210, 310, 410, 510, 610 are incorporated by reference to apply to the bipolar plate 710, except in instances when they conflict with the specific description and the drawings of the bipolar plate 710. Any combination of the components of the bipolar plates 110, 210, 310, 410, 510, 610 and the bipolar plate 710 described in further detail below may be utilized in an assembly of the present disclosure.

As can be seen in FIG. 17, a first manifold 722, also known as an inlet manifold 722, is located in an upper left corner of the plate 710 and includes an inlet distribution area 730, an active area 750, and an exhaust distribution area 760. The inlet distribution area 730 includes a plurality of inlet distribution channels 732 that extend from the inlet manifold 722 to active channels (not shown, but similar to the active channels 152) formed in the active area 750. The plurality of inlet distribution channels 732 are defined between spaced apart protrusions 734.

The protrusions 734 are formed substantially similar to the protrusions 134 described above, except in that the protrusions 734 are segmented along their longitudinal lengths, as shown in FIG. 17. As a result, every inlet distribution channel 732 is inter-connected before reaching the start of the active area 750. Therefore, the pressure difference from the top and bottom of the inlet distribution channels 732 can be balanced or reduced, as every inlet distribution channel 732 is inter-connected before reaching the start of the active area 750. As shown in the FIG. 17, the protrusions 766 of the exhaust distribution channels 762 are also segmented. The segmented channels 732, 762 can be formed on both sheets (not shown, but similar to the sheets 192, 196). An exhaust manifold 778 is located in a lower right corner of the plate 710.

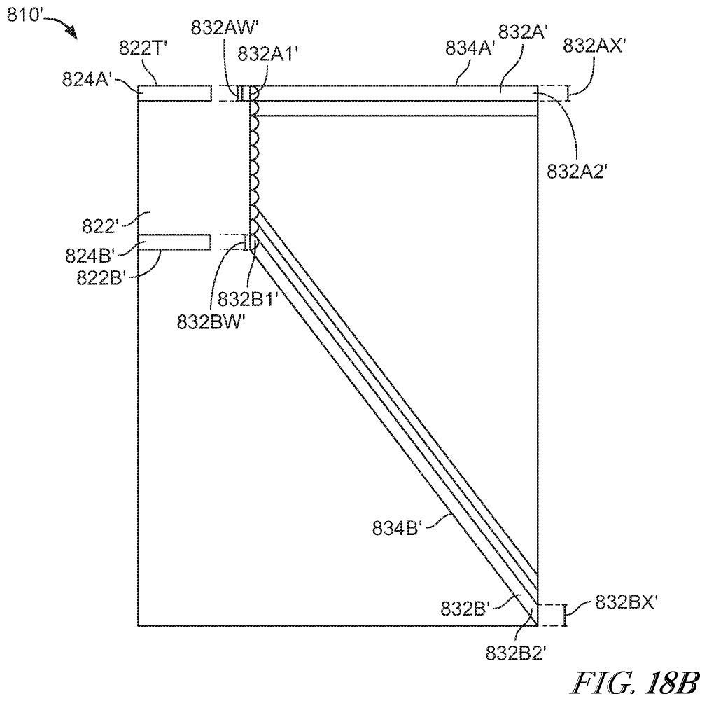

Another embodiment of a bipolar plate 810, 810′ in accordance with the present disclosure is shown in FIGS. 18A and 18B. The bipolar plates 810, 810′ shown in FIGS. 18A and 18B are substantially similar to the bipolar plates 110, 210, 310, 410, 510, 610, 710 described herein. Accordingly, similar reference numbers in the 800, 800′ series indicate features that are common between the bipolar plates 810, 810′ and the bipolar plates 110, 210, 310, 410, 510, 610, 710. The description of the bipolar plates 110, 210, 310, 410, 510, 610, 710 are incorporated by reference to apply to the bipolar plates 810, 810′, except in instances when they conflict with the specific description and the drawings of the bipolar plates 810, 810′. Any combination of the components of the bipolar plates 110, 210, 310, 410, 510, 610, 710 and the bipolar plates 810, 810′ described in further detail below may be utilized in an assembly of the present disclosure. Moreover, the components shown in FIG. 18B substantially correspond to the components shown in FIG. 18A and are thus designated with a prime symbol (e.g. 810′). FIG. 18B differs from FIG. 18A in the particular widths 832AW′, 832AX′, 832BW′, 832BX′ of the inlet distribution channels 832A′, 832B′.

As can be seen in FIG. 18A, a first manifold 822, also known as an inlet manifold 822, is located in an upper left corner of the plate 810. The first manifold 822 includes an inlet distribution area 830 and an active area 850. The first manifold 822 includes a plurality of inlet channels 824A, 824B, 824C, or feed portions 824A, 824B, 824C, configured to facilitate feeding of the fluids 32, 34, 36 described above into the active area 850 of the plate 810 so as to interact with the associated gas diffusion layers 24, 26. The inlet distribution area 830 includes a plurality of inlet distribution channels 832A, 832B, 832C that extend from the inlet manifold 822 to active channels 852 formed by bifurcating lands 856 in the active area 850. The plurality of inlet distribution channels 832 are defined between spaced apart protrusions 834 (834A and 834B). The inlet channels 824A, 824B, 824C and inlet distribution channels 832A, 832B, 832C are only exemplary. The inlet distribution area 830 may include more than three inlet channels 824A, 824B, 824C and three inlet distribution channels 832A, 832B, 832C.

The inlet channels 824A, 824B, 824C and inlet distribution channels 832A, 832B. 832C, shown schematically as the exemplary inlet channels 824A, 824B, 824C and inlet distribution channels 832A, 832B, 832C in FIG. 18A, differ from the inlet channels 124 and the inlet distribution channels 132 described above. The width 832AW, 832BW, 832CW of the inlet channels 824A, 824B, 824C, and thus the width 832AW, 832BW, 832CW at the inlet end 832A1, 832B1, 832C1 of each inlet distribution channel 832A, 832B, 832C, gradually increases from the top 822T of the inlet manifold 822 to the bottom 822B of the inlet manifold 822. For example, the width 832AW of an exemplary top inlet channel 824A is smaller than the width 832BW of an exemplary bottom inlet channel 824B. An exemplary middle inlet channel 824C may have a width 832CW larger than the top width 832A W and smaller than the bottom width 832BW.

In some embodiments, as shown in FIG. 18A, the width 832AW, 832BW, 832CW at the inlet end 832A1, 832B1, 832C1 of the inlet distribution channels 832A, 832B, 832C gradually increases along the length of the inlet distribution channels 832A, 832B, 832C toward an outlet end 832A2, 832B2, 832C2 of the inlet distribution channels 832A, 832B, 832C. As a result, a width 832AX, 832BX, 832CX at the outlet end 832A2, 832B2, 832C2 of each channel 832A, 832B, 832C is greater than the width 832AW, 832BW, 832CW at the inlet end 832A1, 832B1, 832C1 of each inlet distribution channel 832A, 832B, 832C.

In some embodiments, as shown in FIG. 18B, the width 832AW′, 832BW′ at the inlet end 832A1′, 832B1′ of the inlet distribution channels 832A′, 832B′ remains constant along the length of the inlet distribution channels 832A′, 832B′ toward an outlet end 832A2′, 832B2′ of the inlet distribution channels 832A′, 832B′. As a result, a width 832AX′, 832BX′ at the outlet end 832A2′, 832B2′ of each channel 832A′, 832B′ is equal to the width 832AW′, 832BW′ at the inlet end 832A1′, 832B1′ of each inlet distribution channel 832A′, 832B′.

The first manifold 822′ as shown in FIG. 18B includes the plurality of inlet channels 824A′, 824B′, or feed portions 824A′, 824B′, configured to facilitate feeding of the fluids 32, 34, 36 described above into the active area of the plate 810′ so as to interact with the associated gas diffusion layers 24, 26. The plurality of inlet distribution channels 832′ are defined between spaced apart protrusions 834′ (834A′ and 834B′).

The increase of the width 832AW, 832BW, 832CW, 832AW′, 832BW′ at the inlet end 832A1, 832B1, 832C1, 832A1′, 832B1′ of the inlet distribution channels 832A, 832B, 832C, 832A′, 832B′ from the top 822T, 822T′ of the inlet manifold 822, 822′ to the bottom 822B, 822B′ of the inlet manifold 822 aids in compensating for a flow volume difference. The flow volume difference may be caused by flow resistance differences due to the flow distance difference. A person skilled in the art will understand that the width variation described above can also apply to the exhaust manifold (not shown) of the bipolar plates 810, 810′.

The flow resistance can be represented in Equation 5 (note that the channel width 832AW, 832BW, 832CW is represented as a radius (“r”) for an embodiment in which the channels 824A, 824B, 824C, 832A, 832B, 832C each have a circular cross-section):

$$R = ( 8 ( Fluid Viscosity ) ( Length ) ) / ( π {r}^{4} ) \qquad ( 5 )$$

In an exemplary embodiment, a particular design ratio of the width 832AW of the top inlet distribution channel 832A to the width 832BW of the bottom inlet distribution channel 832B can be calculated using Equation 5. A hypothetical resistance R1 of the exemplary top inlet distribution channel 832A can be calculated from a known length L1 and width r1 (832AW) of the inlet distribution channel 832A. Inputting these values into Equation 5: R1=(8(Fluid Viscosity)(L1))/(π(r1)⁴). Similarly, a hypothetical resistance R2 of the exemplary bottom inlet distribution channel 832B can be calculated from a known length L2 and width r2 (832BW) of the inlet distribution channel 832B. Inputting these values into Equation 5: R2=(8(Fluid Viscosity)(L2))/(π(r2)⁴). Rearranging the variables and assuming a balance of flow resistance (or pressure) at the start of the active area 850 (R1=R2), L1/L2=(r1/r2)⁴. As a non-limiting example in which L1/L2= 1/12, r1/r2 will be equal to 1/1.86. As such, in this exemplary embodiment, the width 832BW of the bottom inlet distribution channel 832B is 1.86 times greater than the width 832AW of the top inlet distribution channel 832A.

The described bipolar plates 110, 210, 310, 410, 510, 610, 710, 810, 810′ having the reduced land fractions can improve the bipolar plates 110, 210, 310, 410, 510, 610, 710, 810, 810′ in a variety of aspects. Firstly, non-active distribution areas of the bipolar plates 110, 210, 310, 410, 510, 610, 710, 810, 810′ can be made smaller with smaller land widths, thus resulting in a reduced size of the bipolar plate 110, 210, 310, 410, 510, 610, 710, 810, 810′ and increasing the fuel cell power density through reduction in volume. Moreover, the overall packaging of the bipolar plate 110, 210, 310, 410, 510, 610, 710, 810, 810′ and the overall fuel cell system 10 can be improved, and improved design latitude of the manifolds 122, 142, 148, 172, 174, 178 of the bipolar plate 110, 210, 310, 410, 510, 610, 710, 810, 810′ can be achieved.

The following described aspects of the present invention are contemplated and non-limiting:

A first aspect of the present invention relates to a bipolar plate assembly for a fuel cell. The bipolar plate assembly includes a first bipolar sheet including a plurality of channels. The plurality of channels are formed on a first surface of the first bipolar sheet and extend from a first side of the first bipolar sheet to a second side of the first bipolar plate opposite the first side. The plurality of channels each include a header region, an active region fluidically downstream of and connected to the header region, and an exhaust region fluidically downstream of and connected to the active region. The plurality of channels are formed adjacent to each other and successively from a one side of the first bipolar sheet to another side of the first bipolar sheet. The active region of each channel of the plurality of channels is furcated into at least two active area channels along a longitudinal length of the active region of the channel from a location at which the active region fluidically connects to the header region to a location at which the active region fluidically connects to the exhaust region such that a fluid flows through the header region, through each active area channel, and through the exhaust region. A number of active area channels in the active regions of successive channels varies in a direction from the one side to the another side of the first bipolar sheet so as to achieve a uniform pressure drop and mass flow distribution across the plurality of channels.

A second aspect of the present invention relates to a bipolar plate sheet for a bipolar plate for a fuel cell includes a plurality of channels. The plurality of channels are formed on a first surface of the bipolar plate sheet. The plurality of channels each include an active region. The plurality of channels are formed successively from a top side of the first bipolar sheet to a bottom side of the bipolar plate sheet. The active region of each channel of the plurality of channels is furcated into at least two active area channels. A number of active area channels in the active regions of successive channels increases in one of a direction from the top side to the bottom side of the bipolar plate sheet or a direction from the bottom side to the top side of the bipolar plate sheet so as to achieve a uniform pressure drop and mass flow distribution across the plurality of channels.

A third aspect of the present invention relates to a method of forming a bipolar plate sheet. The method includes forming a plurality of channels on a first surface of the bipolar plate sheet. The plurality of channels extend from a first side of the first bipolar sheet to a second side of the first bipolar plate opposite the first side. The plurality of channels each include a header region, an active region fluidically downstream of and connected to the header region, and an exhaust region fluidically downstream of and connected to the active region. The plurality of channels are formed adjacent to each other and successively from a top side of the first bipolar sheet to a bottom side of the first bipolar sheet. The method further includes furcating the active region of each channel of the plurality of channels into at least two active area channels along a longitudinal length of the active region of the channel from a location at which the active area fluidically connects to the header region to a location at which the active area fluidically connects to the exhaust region such that a fluid flows through the header region, through each active area channel, and through the exhaust region. A number of active area channels in the active regions of successive channels increases in one of a direction from the top side to the bottom side of the first bipolar sheet or a direction from the bottom side to the top side of the first bipolar sheet so as to achieve a uniform pressure drop and mass flow distribution across the plurality of channels.

In the first aspect of the present invention, the header region of each channel of the plurality of channels may be a single channel or is furcated into at least two header region channels, and wherein a furcation ratio of each channel may be defined as a number of header region channels to the number of active area channels of the channel. In the first aspect of the present invention, the furcation ratio of successive channels may increase in the direction from the one side to the another side of the first bipolar sheet.

In the first aspect of the present invention, the plurality of channels may be grouped into at least two groups of channels each including at least one channel of the plurality of channels, and wherein the increase in the furcation ratio of successive groups of channels may be linear from a topmost group of channels to a bottommost group of channels. In the first aspect of the present invention, the plurality of channels may be grouped into at least four groups of channels each including at least one channel of the plurality of channels, and wherein the increase in the furcation ratio of successive groups of channels may be parabolic from a topmost group of channels to a bottommost group of channels.

In the first aspect of the present invention, the plurality of channels may be grouped into five groups of channels each including at least one channel of the plurality of channels, wherein a first group of channels of the five groups of channels may have a furcation ratio of 1:6, wherein a second group of channels of the five groups of channels may have a furcation ratio of 1:7, wherein a third group of channels of the five groups of channels may have a furcation ratio of 1:8, wherein a fourth group of channels of the five groups of channels may have a furcation ratio of 1:9, and wherein a fifth group of channels of the five groups of channels may have a furcation ratio of 1:10.

In the first aspect of the present invention, the plurality of channels may be grouped into at least four groups of channels each including at least one channel of the plurality of channels, wherein a first group of channels of the at least four groups of channels may be located adjacent the one side of the first bipolar sheet and may have a furcation ratio of 3:8, wherein a second group of channels of the at least four groups of channels may be located adjacent the another side of the first bipolar sheet and may have a furcation ratio of 3:19, and wherein a remaining at least two groups of the at least four groups may include furcation ratios that increase parabolically from the first group to the second group.

In the first aspect of the present invention, the header region of each channel of the plurality of channels may be defined between two elongated header lands, and wherein the active region of each channel may be defined between two elongated active lands. In the first aspect of the present invention, a transition region between the header region and the active region of each channel may include at least one island land arranged therein and that is spaced apart from the elongated header lands and the elongated active lands.

In the first aspect of the present invention, a normalized mass flow of the fluid flowing through the active regions of the plurality of channels may vary by a maximum of 10%.

In the second aspect of the present invention, a header region of each channel may be fluidically connected to and upstream of the active region of the channel, wherein the header region of each channel may be a single channel or may be furcated into at least two header region channels, and wherein a furcation ratio of each channel may be defined as a number of header area channels to the number of active area channels of the channel. In the second aspect of the present invention, the furcation ratio of successive channels may increase in the direction from the top side to the bottom side of the bipolar plate sheet, and wherein the number of active area channels may be greater than the number of header channels in each channel.

In the second aspect of the present invention, the plurality of channels may be grouped into at least two groups of channels each including at least one channel of the plurality of channels, and wherein the increase in the furcation ratio of successive groups of channels may be linear from a topmost group of channels to a bottommost group of channels. In the second aspect of the present invention, the plurality of channels may be grouped into at least four groups of channels each including at least one channel of the plurality of channels, and wherein the increase in the furcation ratio of successive groups of channels may be parabolic from a topmost group of channels to a bottommost group of channels.

In the second aspect of the present invention, the plurality of channels may be grouped into five groups of channels each including at least one channel of the plurality of channels, wherein a first group of channels of the five groups of channels may have a furcation ratio of 1:6, wherein a second group of channels of the five groups of channels may have a furcation ratio of 1:7, wherein a third group of channels of the five groups of channels may have a furcation ratio of 1:8, wherein a fourth group of channels of the five groups of channels may have a furcation ratio of 1:9, and wherein a fifth group of channels of the five groups of channels may have a furcation ratio of 1:10. In the second aspect of the present invention, the plurality of channels may be grouped into at least four groups of channels each including at least one channel of the plurality of channels, wherein a first group of channels of the at least four groups of channels may be located adjacent the top side of the bipolar plate sheet and may have a furcation ratio of 3:8, wherein a second group of channels of the at least four groups of channels may be located adjacent the bottom side of the bipolar plate sheet and may have a furcation ratio of 3:19, and wherein a remaining at least two groups of the at least four groups may include furcation ratios that increase parabolically from the first group to the second group.

In the second aspect of the present invention, the header region of a respective channel may begin as a single header channel and may furcate into at least two header region channels which extend into the active region of the respective channel, wherein the exhaust region of the respective channel may be furcated into at least two exhaust region channels at an exit of the active region of the respective channel and may converge into a single exhaust channel, and wherein a number of channels of the at least two exhaust region channels may be different that a number of channels of the at least two header region channels.

In the second aspect of the present invention, the header region of a respective channel may begin as a single header channel and may furcate into at least two header region channels which extend into the active region of the respective channel, wherein the exhaust region of the respective channel may be furcated into at least two exhaust region channels at an exit of the active region of the respective channel and may converge into a single exhaust channel, and wherein a number of channels of the at least two exhaust region channels may be equal to a number of channels of the at least two header region channels.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A bipolar plate assembly for a fuel cell, comprising:
a first bipolar sheet including a plurality of channels formed on a first surface of the first bipolar sheet and extending from a first side of the first bipolar sheet to a second side of the first bipolar plate opposite the first side, the plurality of channels each including a header region, an active region fluidically downstream of and connected to the header region, and an exhaust region fluidically downstream of and connected to the active region,
wherein the plurality of channels are formed adjacent to each other and successively from one side of the first bipolar sheet to another side of the first bipolar sheet,
wherein the active region of each channel of the plurality of channels is furcated into at least two active area channels along a longitudinal length of the active region of the channel from a location at which the active region fluidically connects to the header region to a location at which the active region fluidically connects to the exhaust region such that a fluid flows through the header region, through each active area channel, and through the exhaust region, and
wherein a number of active area channels in the active regions of successive channels varies in a direction from the one side to the another side of the first bipolar sheet so as to achieve a uniform pressure drop and mass flow distribution across the plurality of channels.

2. The bipolar plate assembly of claim 1, wherein the header region of each channel of the plurality of channels is a single channel or is furcated into at least two header region channels, and wherein a furcation ratio of each channel is defined as a number of header region channels to the number of active area channels of the channel.

3. The bipolar plate assembly of claim 2, wherein the furcation ratio of successive channels increases in the direction from the one side to the another side of the first bipolar sheet.

4. The bipolar plate assembly of claim 3, wherein the plurality of channels are grouped into at least two groups of channels each including at least one channel of the plurality of channels, and wherein the increase in the furcation ratio of successive groups of channels is linear from a topmost group of channels to a bottommost group of channels.

5. The bipolar plate assembly of claim 3, wherein the plurality of channels are grouped into at least four groups of channels each including at least one channel of the plurality of channels, and wherein the increase in the furcation ratio of successive groups of channels is parabolic from a topmost group of channels to a bottommost group of channels.

6. The bipolar plate assembly of claim 3, wherein the plurality of channels are grouped into five groups of channels each including at least one channel of the plurality of channels, wherein a first group of channels of the five groups of channels has a furcation ratio of 1:6, wherein a second group of channels of the five groups of channels has a furcation ratio of 1:7, wherein a third group of channels of the five groups of channels has a furcation ratio of 1:8, wherein a fourth group of channels of the five groups of channels has a furcation ratio of 1:9, and wherein a fifth group of channels of the five groups of channels has a furcation ratio of 1:10.

7. The bipolar plate assembly of claim 3, wherein the plurality of channels are grouped into at least four groups of channels each including at least one channel of the plurality of channels, wherein a first group of channels of the at least four groups of channels is located adjacent the one side of the first bipolar sheet and has a furcation ratio of 3:8, wherein a second group of channels of the at least four groups of channels is located adjacent the another side of the first bipolar sheet and has a furcation ratio of 3:19, and wherein a remaining at least two groups of the at least four groups include furcation ratios that increase parabolically from the first group to the second group.

8. The bipolar plate assembly of claim 1, wherein the header region of each channel of the plurality of channels is defined between two elongated header lands, and wherein the active region of each channel is defined between two elongated active lands.

9. The bipolar plate assembly of claim 8, wherein a transition region between the header region and the active region of each channel includes at least one island land arranged therein and that is spaced apart from the elongated header lands and the elongated active lands.

10. The bipolar plate assembly of claim 1, wherein a normalized mass flow of the fluid flowing through the active regions of the plurality of channels varies by a maximum of 10%.

11. A bipolar plate sheet for a bipolar plate for a fuel cell, comprising:
a plurality of channels formed on a first surface of the bipolar plate sheet, the plurality of channels each including an active region,
wherein the plurality of channels are formed successively from a top side of the first bipolar sheet to a bottom side of the bipolar plate sheet,
wherein the active region of each channel of the plurality of channels is furcated into at least two active area channels, and
wherein a number of active area channels in the active regions of successive channels increases in one of a direction from the top side to the bottom side of the bipolar plate sheet or a direction from the bottom side to the top side of the bipolar plate sheet so as to achieve a uniform pressure drop and mass flow distribution across the plurality of channels.

12. The bipolar plate sheet of claim 11, wherein a header region of each channel is fluidically connected to and upstream of the active region of the channel, wherein the header region of each channel is a single channel or is furcated into at least two header region channels, and wherein a furcation ratio of each channel is defined as a number of header area channels to the number of active area channels of the channel.

13. The bipolar plate sheet of claim 12, wherein the furcation ratio of successive channels increases in the direction from the top side to the bottom side of the bipolar plate sheet, and wherein the number of active area channels is greater than the number of header channels in each channel.

14. The bipolar plate sheet of claim 13, wherein the plurality of channels are grouped into at least two groups of channels each including at least one channel of the plurality of channels, and wherein the increase in the furcation ratio of successive groups of channels is linear from a topmost group of channels to a bottommost group of channels.

15. The bipolar plate sheet of claim 13, wherein the plurality of channels are grouped into at least four groups of channels each including at least one channel of the plurality of channels, and wherein the increase in the furcation ratio of successive groups of channels is parabolic from a topmost group of channels to a bottommost group of channels.

16. The bipolar plate sheet of claim 13, wherein the plurality of channels are grouped into five groups of channels each including at least one channel of the plurality of channels, wherein a first group of channels of the five groups of channels has a furcation ratio of 1:6, wherein a second group of channels of the five groups of channels has a furcation ratio of 1:7, wherein a third group of channels of the five groups of channels has a furcation ratio of 1:8, wherein a fourth group of channels of the five groups of channels has a furcation ratio of 1:9, and wherein a fifth group of channels of the five groups of channels has a furcation ratio of 1:10.

17. The bipolar plate sheet of claim 13, wherein the plurality of channels are grouped into at least four groups of channels each including at least one channel of the plurality of channels, wherein a first group of channels of the at least four groups of channels is located adjacent the top side of the bipolar plate sheet and has a furcation ratio of 3:8, wherein a second group of channels of the at least four groups of channels is located adjacent the bottom side of the bipolar plate sheet and has a furcation ratio of 3:19, and wherein a remaining at least two groups of the at least four groups include furcation ratios that increase parabolically from the first group to the second group.

18. The bipolar plate sheet of claim 13, wherein the header region of a respective channel begins as a single header channel and furcates into at least two header region channels which extend into the active region of the respective channel, wherein the exhaust region of the respective channel is furcated into at least two exhaust region channels at an exit of the active region of the respective channel and converges into a single exhaust channel, and wherein a number of channels of the at least two exhaust region channels is different that a number of channels of the at least two header region channels.

19. The bipolar plate sheet of claim 13, wherein the header region of a respective channel begins as a single header channel and furcates into at least two header region channels which extend into the active region of the respective channel, wherein the exhaust region of the respective channel is furcated into at least two exhaust region channels at an exit of the active region of the respective channel and converges into a single exhaust channel, and wherein a number of channels of the at least two exhaust region channels is equal to a number of channels of the at least two header region channels.

20. A method of forming a bipolar plate sheet, comprising:
forming a plurality of channels on a first surface of the bipolar plate sheet, the plurality of channels extending from a first side of the first bipolar sheet to a second side of the first bipolar plate opposite the first side, the plurality of channels each including a header region, an active region fluidically downstream of and connected to the header region, and an exhaust region fluidically downstream of and connected to the active region, wherein the plurality of channels are formed adjacent to each other and successively from a top side of the first bipolar sheet to a bottom side of the first bipolar sheet; and
furcating the active region of each channel of the plurality of channels into at least two active area channels along a longitudinal length of the active region of the channel from a location at which the active area fluidically connects to the header region to a location at which the active area fluidically connects to the exhaust region such that a fluid flows through the header region, through each active area channel, and through the exhaust region, wherein a number of active area channels in the active regions of successive channels increases in one of a direction from the top side to the bottom side of the first bipolar sheet or a direction from the bottom side to the top side of the first bipolar sheet so as to achieve a uniform pressure drop and mass flow distribution across the plurality of channels.
